(19) United States
(12) Patent Application Publication
(10) Pub. No.: US 2013/0081052 A1
(43) Pub. Date: Mar. 28, 2013

(54) Acquiring tasks and subtasks to be carried out by interface devices

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/374,514

(22) Filed: Dec. 30, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation-in-part of application No. 13/317,591, filed on Oct. 21, 2011.
Application No. 13/317,591 is a continuation-in-part of application No. 13/317,833, filed on Oct. 28, 2011.
Application No. 13/317,833 is a continuation-in-part of application No. 13/373,795, filed on Nov. 29, 2011.
Application No. 13/373,795 is a continuation-in-part of application No. 13/373,794, filed on Nov. 29, 2011.
Application No. 13/373,794 is a continuation-in-part of application No. 13/373,826, filed on Nov. 30, 2011.
Application No. 13/373,826 is a continuation-in-part of application No. 13/373,829, filed on Nov. 30, 2011.
Application No. 13/373,829 is a continuation of application No. 13/374,512, filed on Dec. 30, 2011.
Application No. 13/374,512 is a continuation-in-part of application No. 13/374,529, filed on Dec. 30, 2011.
Application No. 13/374,529 is a continuation-in-part of application No. 13/374,527, filed on Dec. 30, 2011.
Application No. 13/374,527 is a continuation-in-part of application No. 13/374,511, filed on Dec. 30, 2011.
Application No. 13/374,511 is a continuation-in-part of application No. 13/374,518, filed on Dec. 30, 2011.
Application No. 13/374,518 is a continuation-in-part of application No. 13/374,522, filed on Dec. 30, 2011.
Application No. 13/374,522 is a continuation-in-part of application No. 13/341,901, filed on Dec. 30, 2011.

(51) Int. Cl. G06F 9/46; G06F 15/16

(52) U.S. Cl. 718/106

(57) ABSTRACT

Computationally implemented methods and systems include receiving a request to carry out a task of acquiring data requested by a task requestor, acquiring one or more subtasks related to the task of acquiring data, determining a set of two or more discrete interface devices that are configured to carry out the one or more subtasks at a particular time and in an absence of information regarding the at least one task and/or the task requestor, and facilitating a transmission of one or more subtasks to two or more of the set of two or more discrete interface devices. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,591, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,833, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,795, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,794, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,826, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,829, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to receiving a request to carry out a task of acquiring data requested by a task requestor, acquiring one or more subtasks related to the task of acquiring data, determining a set of two or more discrete interface devices that are configured to carry out the one or more subtasks at a particular time and in an absence of information regarding the at least one task and/or the task requestor, and facilitating a transmission of one or more subtasks to two or more of the set of two or more discrete interface devices. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally implemented system includes, but is not limited to means for receiving a request to carry out a task of acquiring data requested by a task requestor, means for acquiring one or more subtasks related to the task of acquiring data, means for determining a set of two or more discrete interface devices that are configured to carry out the one or more subtasks at a particular time and in an absence of information regarding the at least one task and/or the task requestor, and means for facilitating a transmission of one or more subtasks to two or more of the set of two or more discrete interface devices.

A computationally implemented system includes, but is not limited to circuitry for receiving a request to carry out a task of acquiring data requested by a task requestor, circuitry for acquiring one or more subtasks related to the task of acquiring data, circuitry for determining a set of two or more discrete interface devices that are configured to carry out the one or more subtasks at a particular time and in an absence of information regarding the at least one task and/or the task requestor, and circuitry for facilitating a transmission of one or more subtasks to two or more of the set of two or more discrete interface devices.

A computer program product comprising an article of manufacture bears instructions including but not limited to one or more instructions for receiving a request to carry out a task of acquiring data requested by a task requestor, one or more instructions for acquiring one or more subtasks related to the task of acquiring data, one or more instructions for determining a set of two or more discrete interface devices that are configured to carry out the one or more subtasks at a particular time and in an absence of information regarding the at least one task and/or the task requestor, and one or more instructions for facilitating a transmission of one or more subtasks to two or more of the set of two or more discrete interface devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2A including FIGS. 2A1 through 2A2, shows a particular perspective of the task of acquiring data request receiving module 52 of the computing device 30 of environment 100 of FIG. 1.

FIG. 2B shows a particular perspective of related subtask acquiring module 54 of the computing device 30 of environment 100 of FIG. 1.

FIG. 3, including FIGS. 3A-3I, shows a particular perspective of the two-or-more absent information configured discrete interface device set determining module 56 of the computing device 30 of environment 100 of FIG. 1.

FIG. 4 shows a particular perspective of the discrete interface device set transmission facilitation module 58 of the computing device 30 of environment 100 of FIG. 1.

FIG. 5 is a high-level logic flowchart of a process, e.g., operational flow 500, according to an embodiment.

FIG. 6A is a high-level logic flowchart of a process depicting alternate implementations of a receiving a request to carry out a task of acquiring data requested by a task requestor operation 502 of FIG. 5.

FIG. 6B is a high-level logic flowchart of a process depicting alternate implementations of a receiving a request to carry out a task of acquiring data requested by a task requestor operation 502 of FIG. 5

FIG. 7 is a high-level logic flowchart of a process depicting alternate implementations of an acquiring one or more subtasks related to the task of acquiring data operation 504 of FIG. 5.

FIG. 8A is a high-level logic flowchart of a process depicting alternate implementations of a determining a set of two or more discrete interface devices operation 506 of FIG. 5.

FIG. 8B is a high-level logic flowchart of a process depicting alternate implementations of a determining a set of two or more discrete interface devices operation 506 of FIG. 5.

FIG. 8C is a high-level logic flowchart of a process depicting alternate implementations of a determining a set of two or more discrete interface devices operation 506 of FIG. 5.

FIG. 8D is a high-level logic flowchart of a process depicting alternate implementations of a determining a set of two or more discrete interface devices operation 506 of FIG. 5.

FIG. 8E is a high-level logic flowchart of a process depicting alternate implementations of a determining a set of two or more discrete interface devices operation 506 of FIG. 5.

FIG. 8F is a high-level logic flowchart of a process depicting alternate implementations of a determining a set of two or more discrete interface devices operation 506 of FIG. 5.

FIG. 8G is a high-level logic flowchart of a process depicting alternate implementations of a determining a set of two or more discrete interface devices operation 506 of FIG. 5.

FIG. 8H is a high-level logic flowchart of a process depicting alternate implementations of a determining a set of two or more discrete interface devices operation 506 of FIG. 5.

FIG. 8I is a high-level logic flowchart of a process depicting alternate implementations of a determining a set of two or more discrete interface devices operation 506 of FIG. 5.

FIG. 8J is a high-level logic flowchart of a process depicting alternate implementations of a determining a set of two or more discrete interface devices operation 506 of FIG. 5.

FIG. 9 is a high-level logic flowchart of a process depicting alternate implementations of a facilitating a transmission of one or more subtasks to two or more of the set of two or more discrete interface devices operation 508 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries that do not contain a large number of portable computing devices at any given time. These portable computing devices are constantly collecting data, and capable of collecting data, which is not stored in any repository or transmitted to any device that may use such data. Thus, such data, and opportunity to collect data, may be lost.

In accordance with various embodiments, computationally implemented methods, systems, and articles of manufacture are provided for receiving a request to carry out a task of acquiring data requested by a task requestor, acquiring one or more subtasks related to the task of acquiring data, determining a set of two or more discrete interface devices that are configured to carry out the one or more subtasks at a particular time and in an absence of information regarding the at least one task and/or the task requestor, and facilitating a transmission of one or more subtasks to two or more of the set of two or more discrete interface devices.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

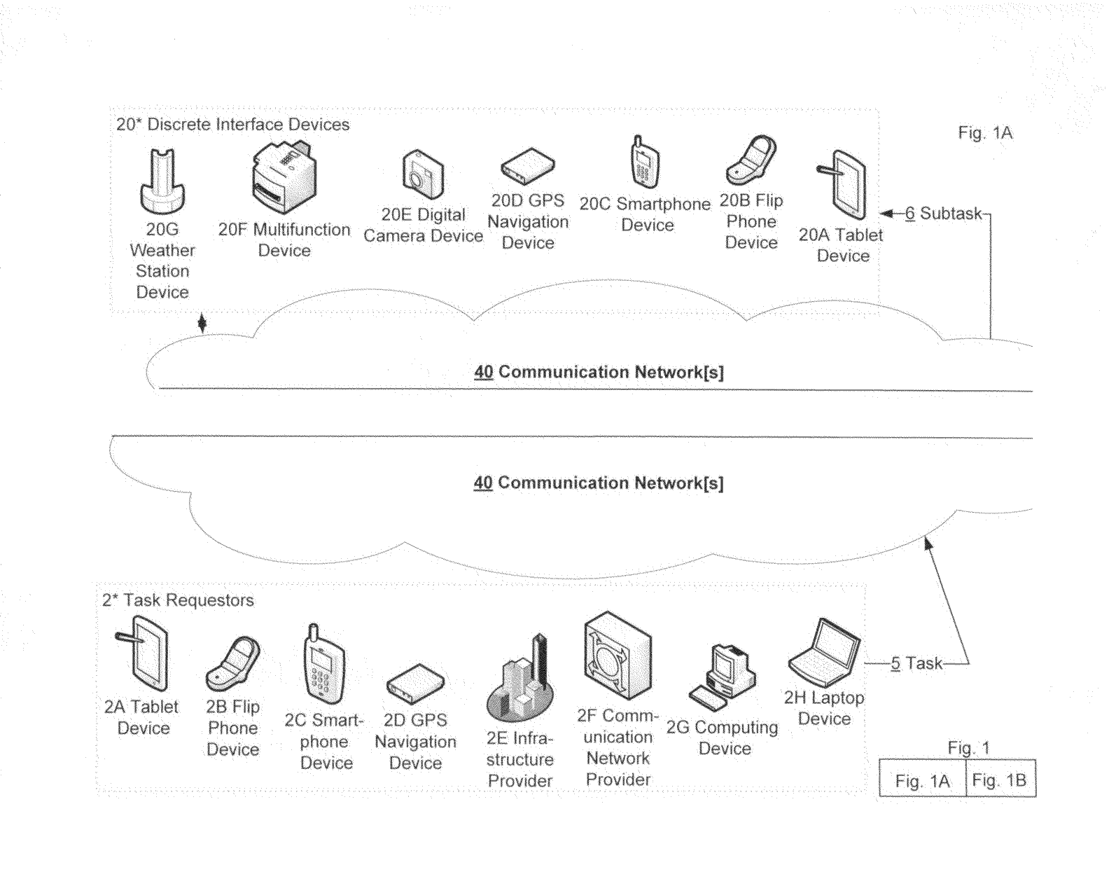

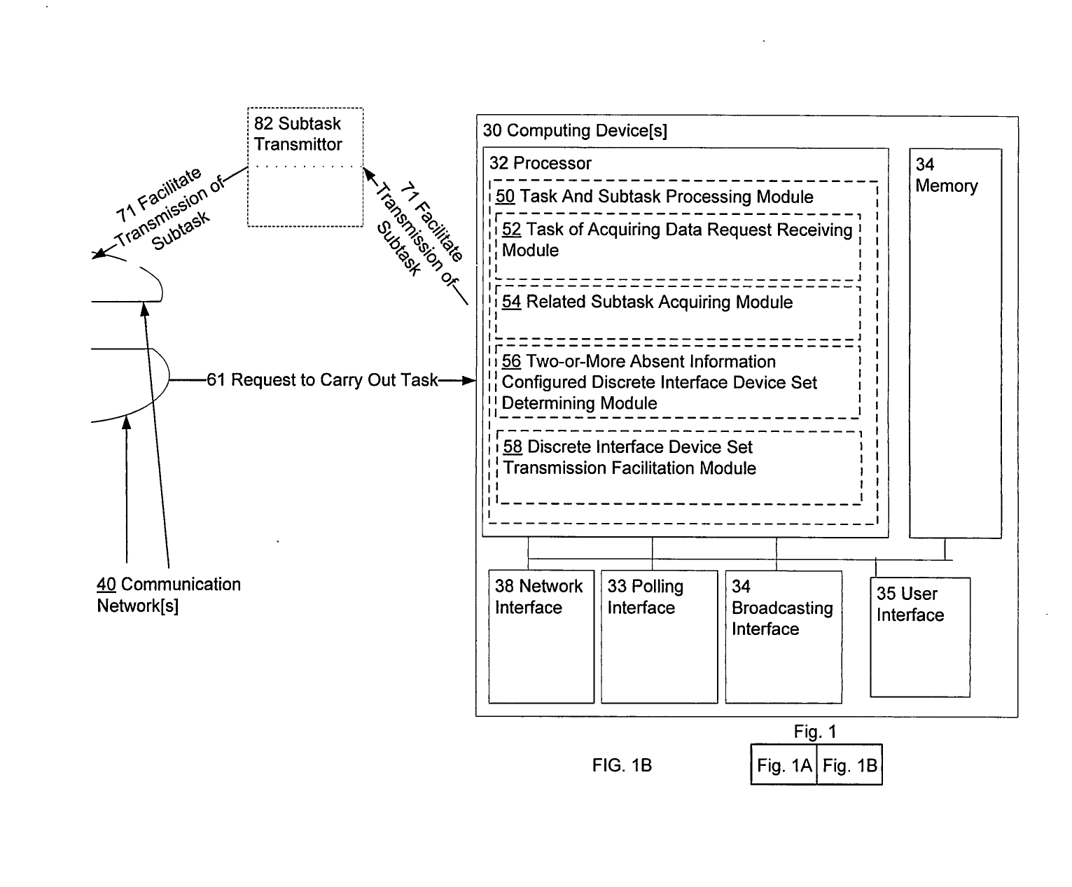

Referring now to FIG. 1, FIG. 1 illustrates a computing device 30 in an exemplary environment 100. As will be described in more detail herein, the computing device 30 may employ the computationally implemented methods, systems, and articles of manufacture in accordance with various embodiments. The computing device 30, in various embodiments, may be endowed with logic that is designed to acquire one or more subtasks that correspond to portions of a task of acquiring data requested by a task requestor, wherein the task of acquiring data is configured to be carried out by two or more discrete interface devices, transmit at least one of the one or more subtasks to at least two of the two or more discrete interface devices, wherein the one or more subtasks are configured to be carried out in an absence of information regarding the task requestor and/or the task of acquiring data, and receive result data corresponding to a result of an executed one or more subtasks

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Similarly, interface devices 20* of FIG. 1 may be in reference to tablet device 20A, flip phone device 20B, smartphone device 20C, GPS navigation device 20D, digital camera device 20E, multifunction device 20F, and weather station device 20G. These drawings are meant to be illustrative only, and should not be construed as limiting the definition of interface devices 20*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules that will be discussed in more detail herein. Specifically, these particular modules may be implemented across different networks and systems, and may be partially or wholly unaware of each other, except for the need to transmit data as indicated by the arrows within computing device 30.

A task 5 sent from a task requestor 2* may be received by computing device 30, and separated into its component subtasks. In other embodiments, a task 5 sent from a task requestor 2* may be received by another computing device (not shown), and separated into its component subtasks, which then may be sent to computing device 30. In some embodiments, the another computing device may rely on partial human intervention to be separated into its component subtasks. In other embodiments, the another computing device may be entirely automated, and may use such techniques as are known in the art to separate tasks into subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other. It is further noted, that, in this drawing, communication network 40 is shown having a split between the task requestors 2* and the discrete interface devices 20*. This is because, in embodiments, the discrete interface devices 20* cannot communicate with the task requestors 2*. As will be discussed in more detail herein, the discrete interface devices 20* operate with a smaller subset of information than what is available to task requestors 2* regarding the nature of the task and/or the task requestor, e.g., discrete interface devices 20* operate in an “absence of information regarding the task and/or the task requestor.”

Computing device 30 may include a network interface module 38 to facilitate communications with communications network 40. Network interface module 38, which may be implemented as hardware or software, or both, used to interface the computing device 30 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

Computing device 30 also may include a polling interface 33 and a broadcasting interface 34, which also may interface with communications network 40. Polling interface 33 and broadcasting interface 34 also may be implemented as hardware or software, or both, and may share component parts and/or machine-readable instructions with network interface module 38. In some embodiments, the same hardware and/or software is used to implement network interface 38, polling interface 33, and broadcasting interface 34. The specific functions of these devices will be discussed in more detail herein with respect to the modules and computationally-implemented methods described herein.

As shown in FIG. 1, computing device 30 may receive a request to acquire data 61, e.g., a request for a task. This request may come either directly from the task requestors 2* or from another computing device (not shown) that collects and/or processes the tasks received from task requestors 2*.

Further, as shown in FIG. 1, computing device 30 may facilitate transmission of subtask data. This may include transmitting a set of discrete interface devices to a subtask transmitter 82, which entity then may distribute the subtasks in accordance with the set, or using its own further criteria. In some embodiments, facilitating transmission of subtask data 71 includes transmitting the subtasks to the discrete interface devices directly.

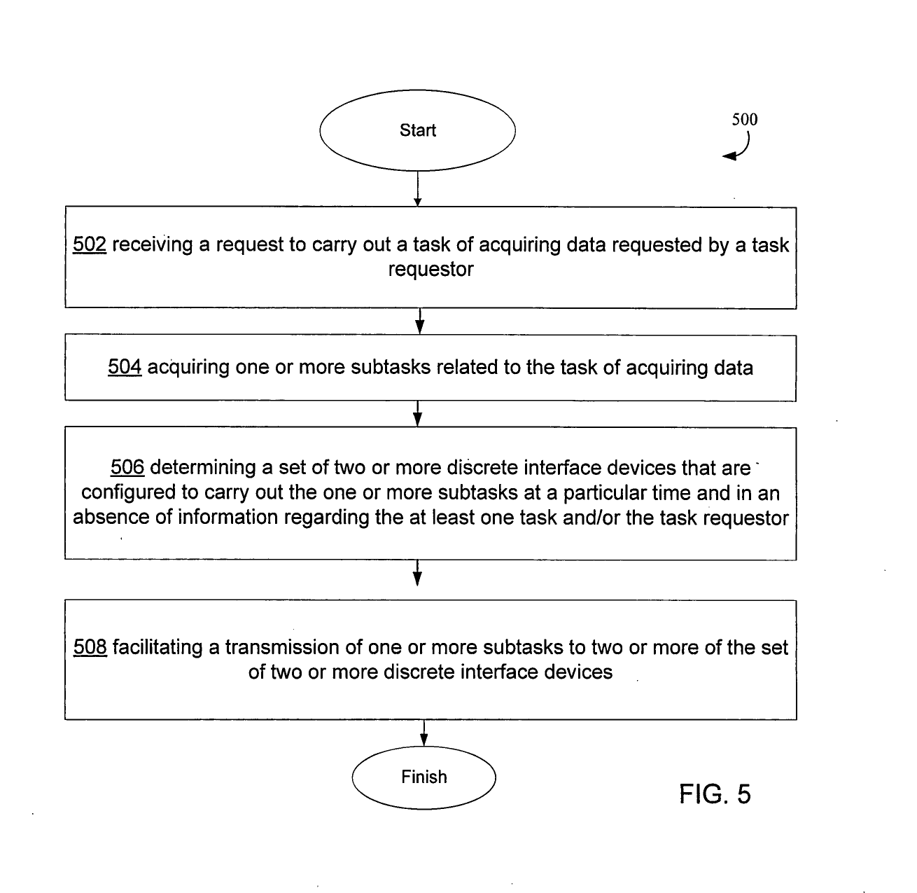

Referring again to the example environment 100 of FIG. 1, in various embodiments, the computing device 30 may comprise, among other elements, a processor 32, a memory 34, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5C, 6A-6E, and 7A-7G. In some embodiments, processor 32 is designed to be configured to operate as the subtask module 50, which may include task portion two-or-more discrete interface device subtask acquiring module 52, absent knowledge of task and/or task requestor information subtask transmitting module 54, and executed subtask result data receiving module 56.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

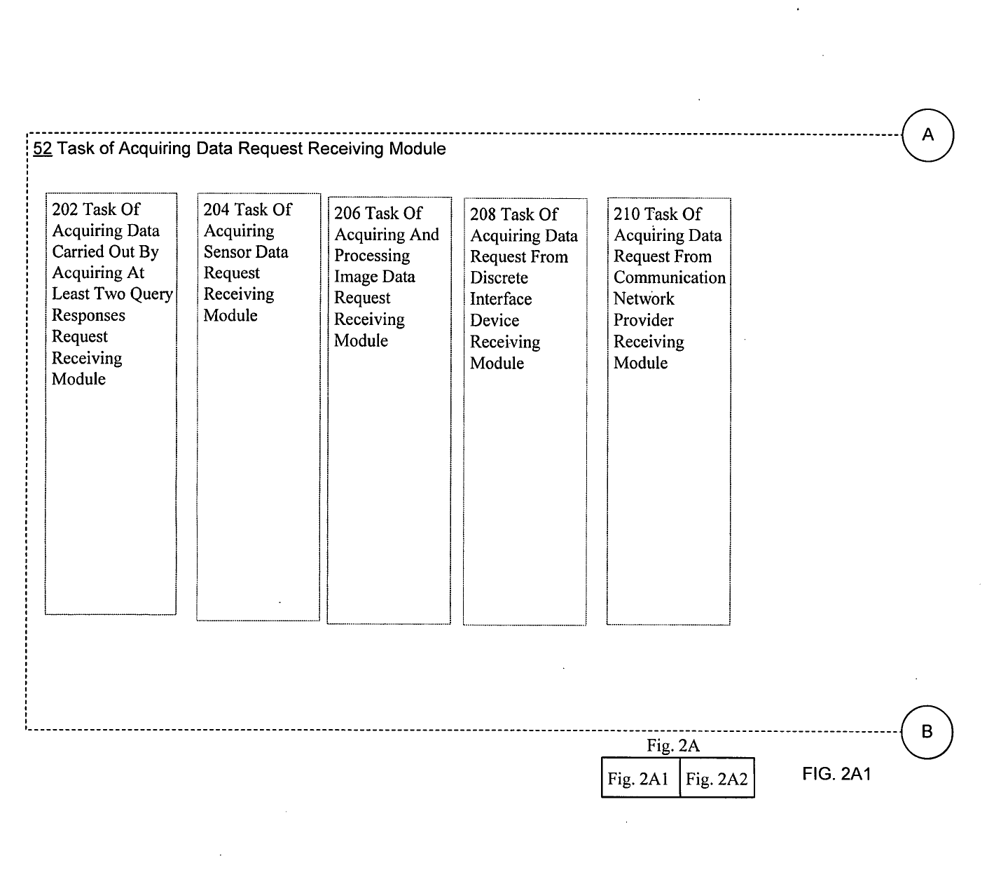

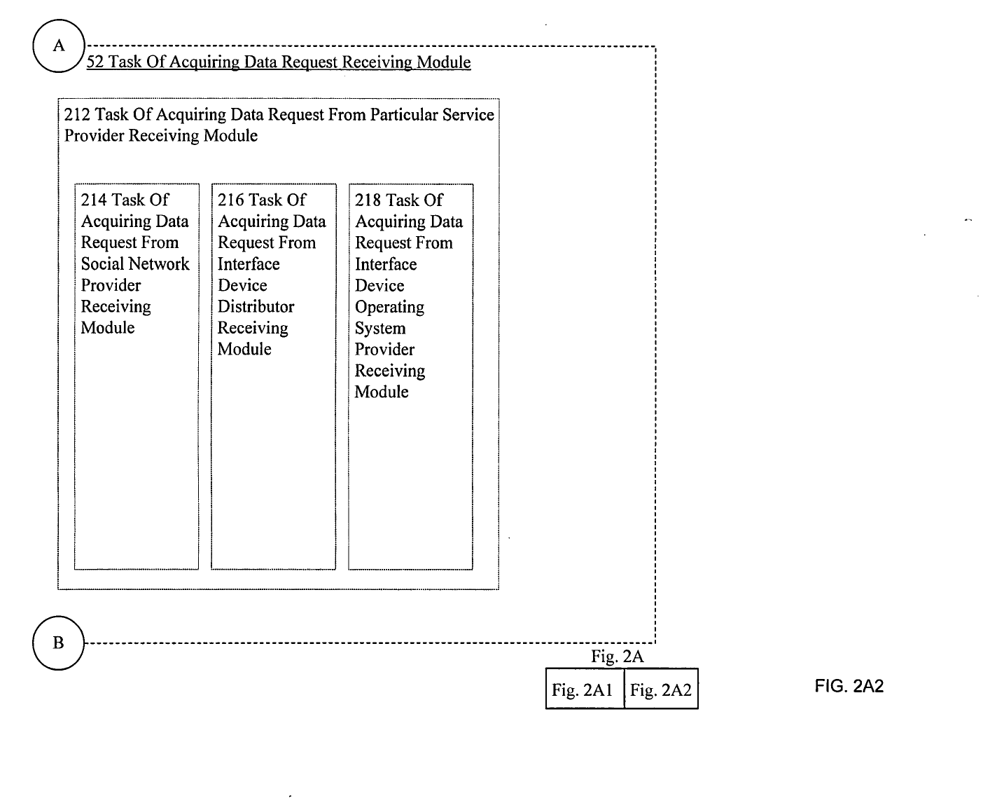

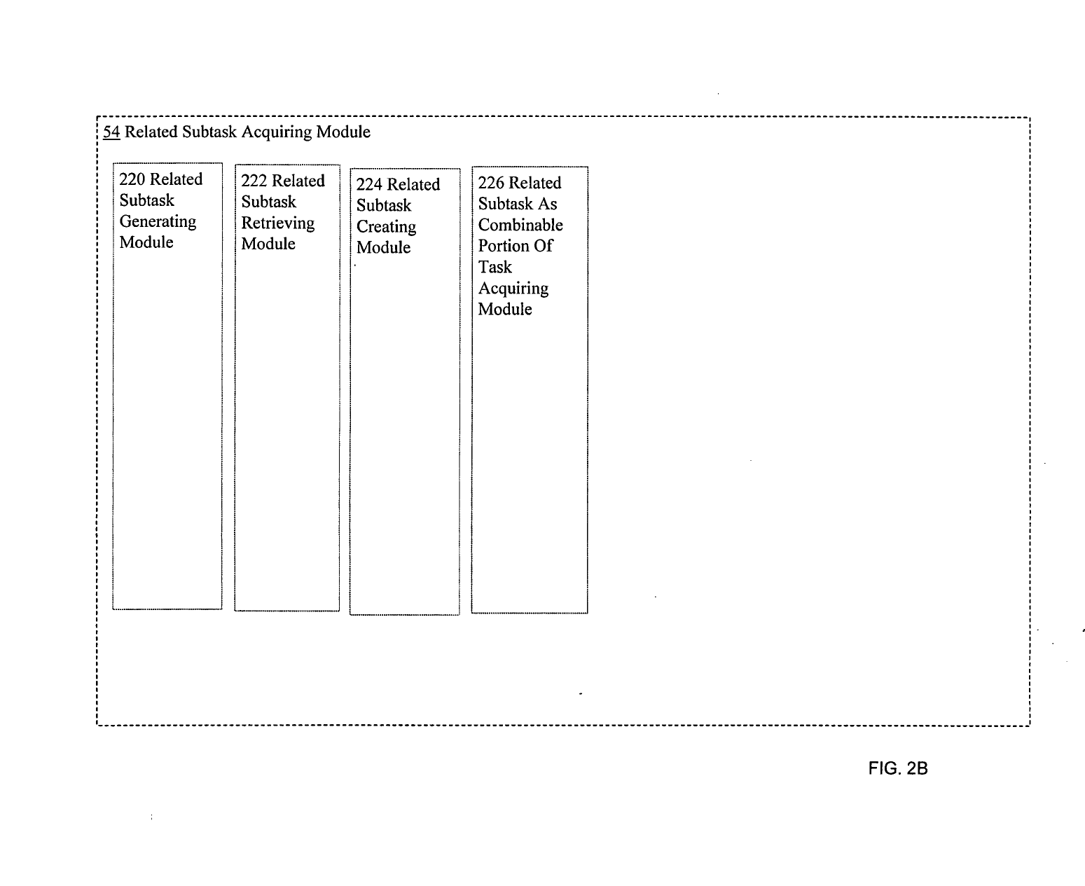

Referring now to FIG. 2A, FIG. 2A illustrates an exemplary implementation of the task of acquiring data request receiving module 52 of the module 50. As illustrated in FIG. 2A, the task of acquiring data request receiving module 52 may include one or more sub-logic modules in various alternative implementations and embodiments. For example, in some embodiments, module 52 may include a task of acquiring data carried out by acquiring at least two query responses request receiving module 202, a task of acquiring sensor data request receiving module 204, a task of acquiring and processing image data request receiving module 206, a task of acquiring data request from discrete interface device receiving module 208, a task of acquiring data request from communication network provider receiving module 210, and a task of acquiring data request from a particular service provider receiving module 212. In some embodiments, module 212 may include a task of acquiring data request from social network provider receiving module 214, a task of acquiring data request from interface device distributor receiving module 216, and task of acquiring data request from interface device operating system provider receiving module 218.

Referring now to FIG. 2B, FIG. 2B illustrates an exemplary implementation of related subtask acquiring module 54. As illustrated in FIG. 2B, the related subtask acquiring module 54 may include one or more sub-logic modules in various alternative implementations and embodiments. For example, in some embodiments, module 54 may include related subtask generating module 220, related subtask retrieving module 222, related subtask creating module 224, and related subtask as combinable portion of task acquiring module 226.

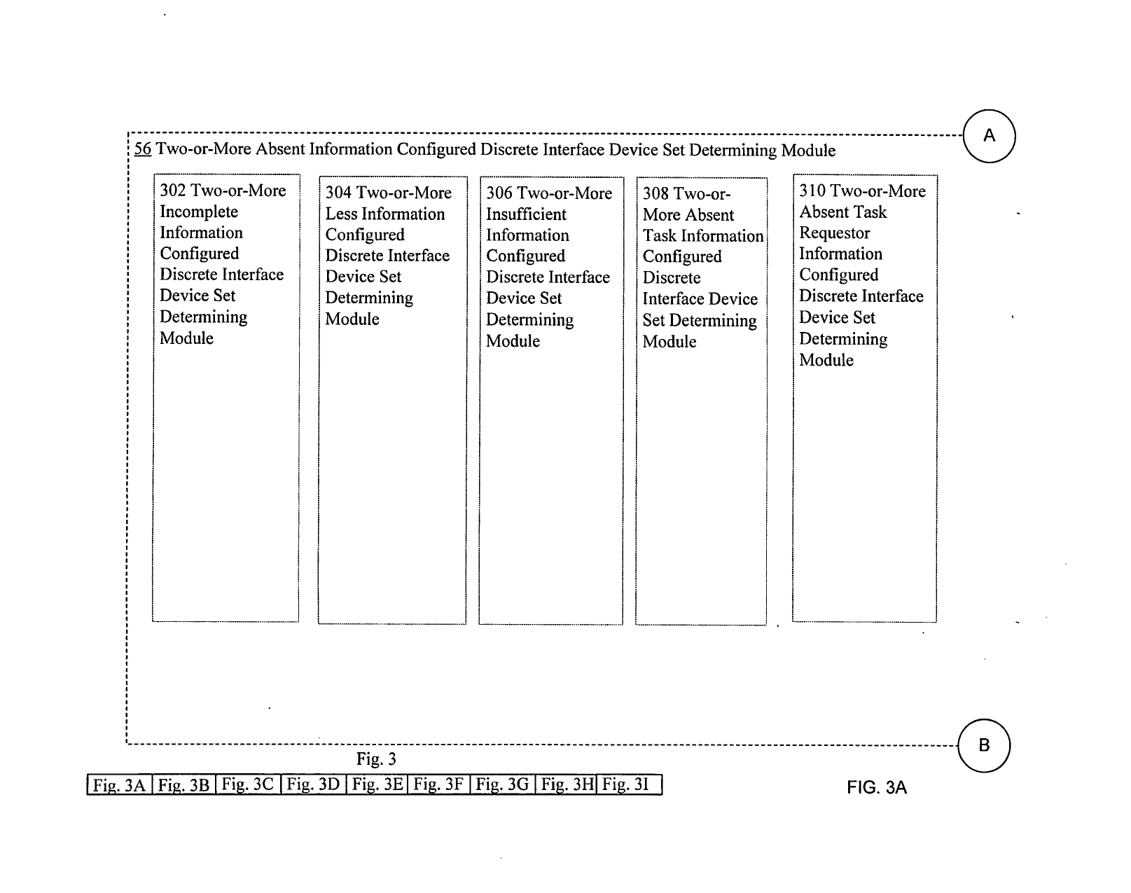

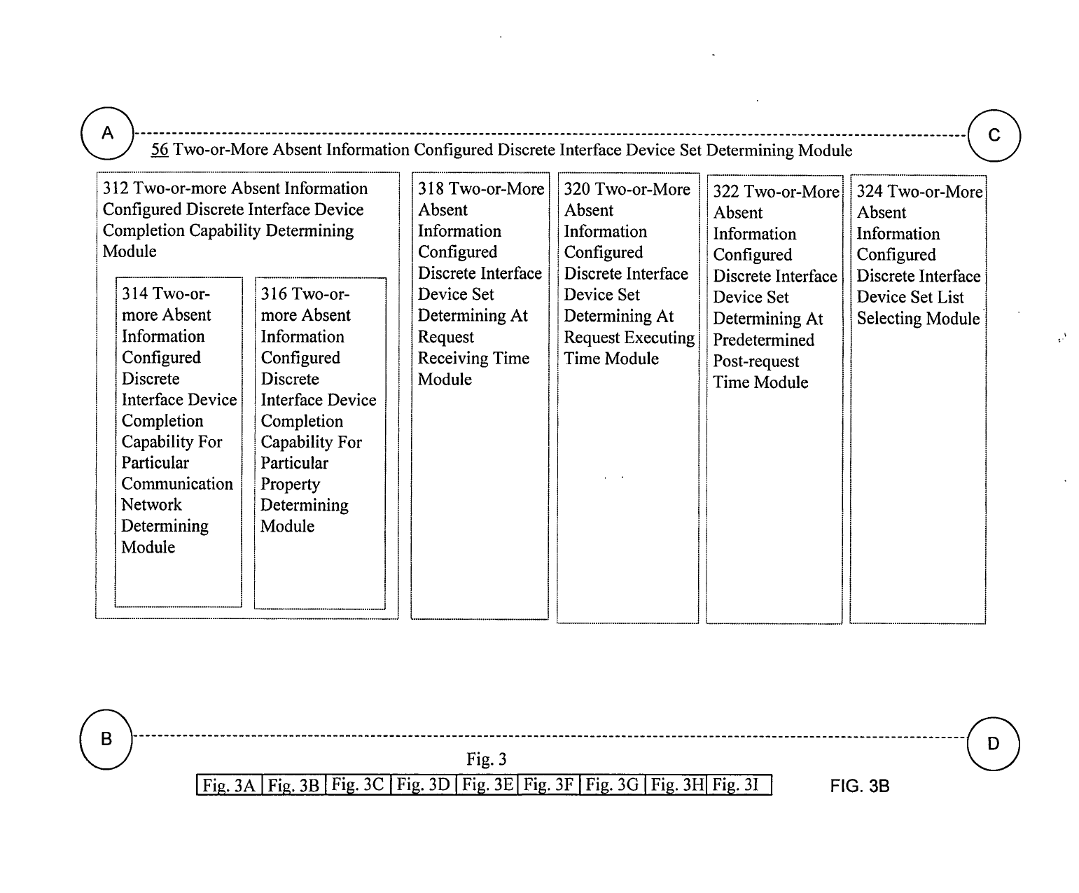

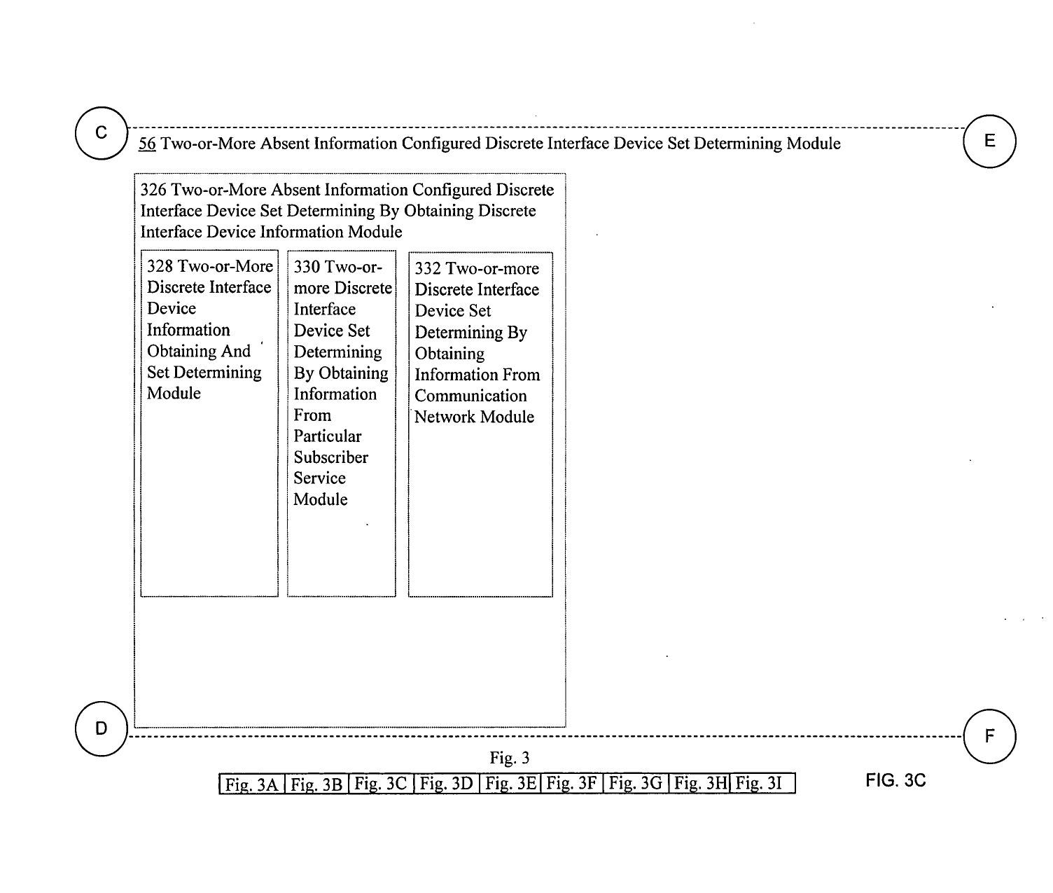

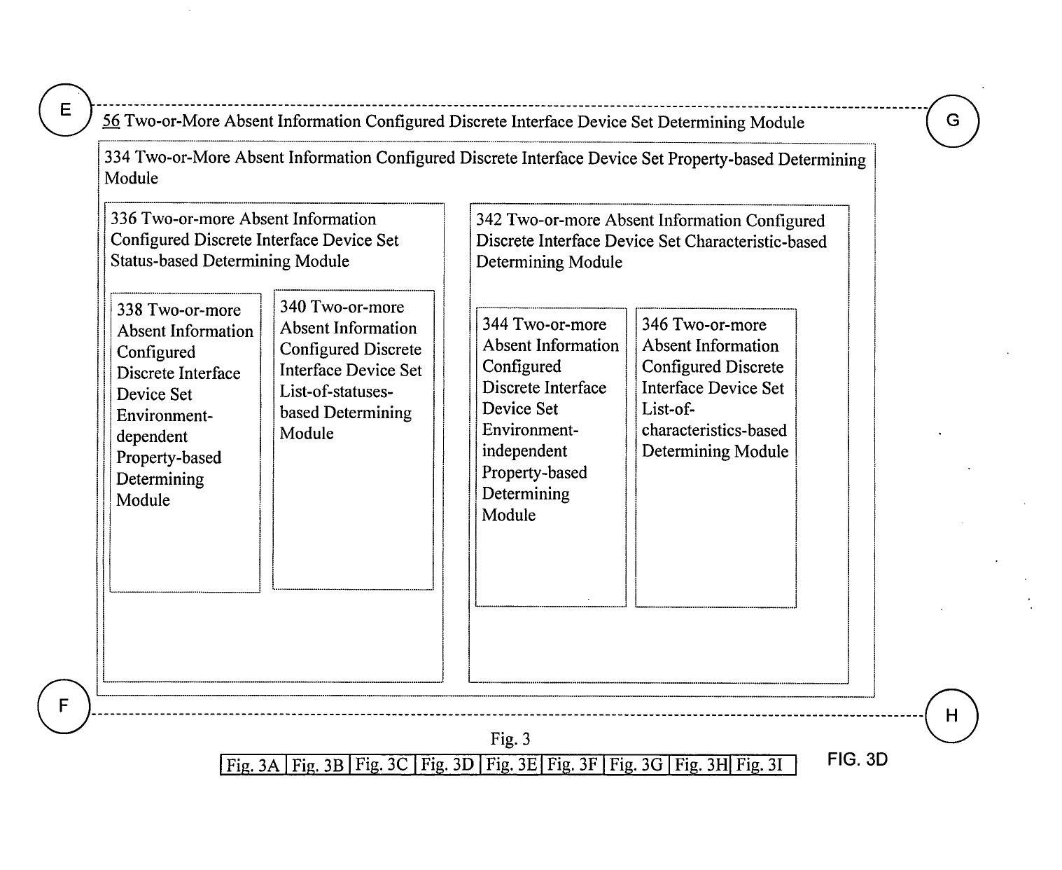

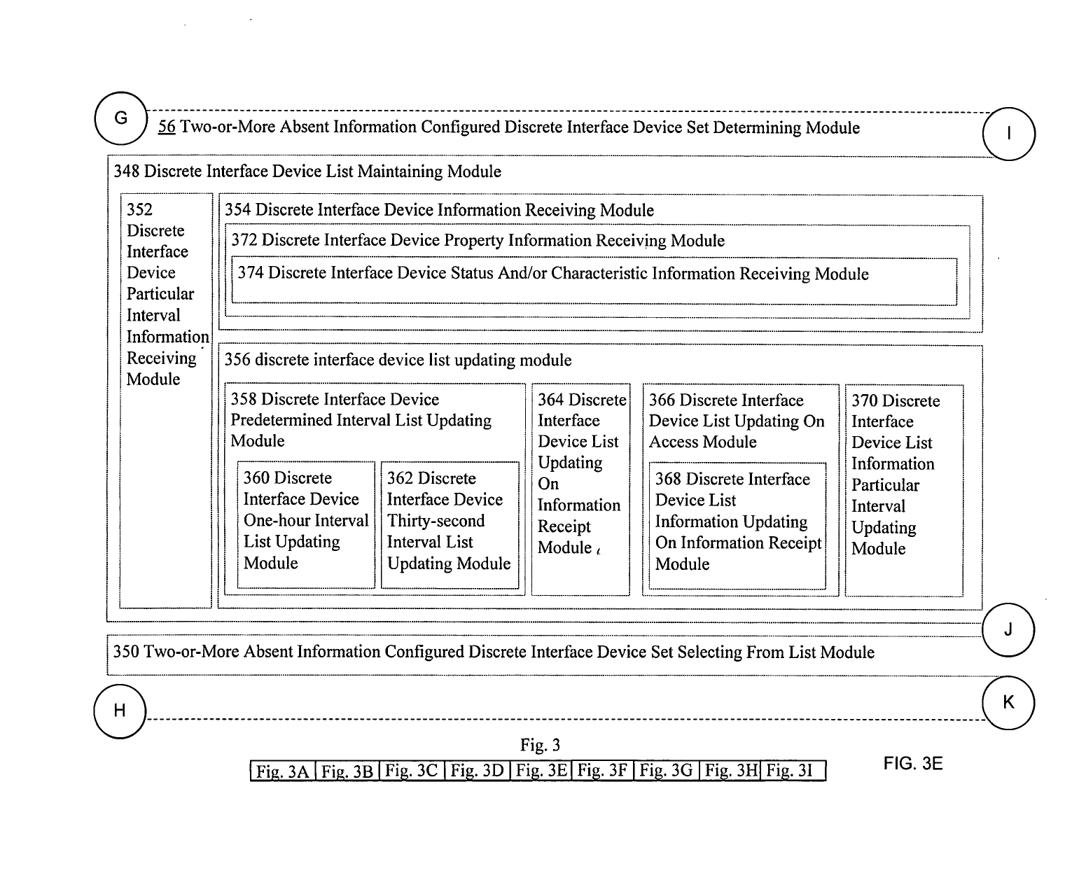

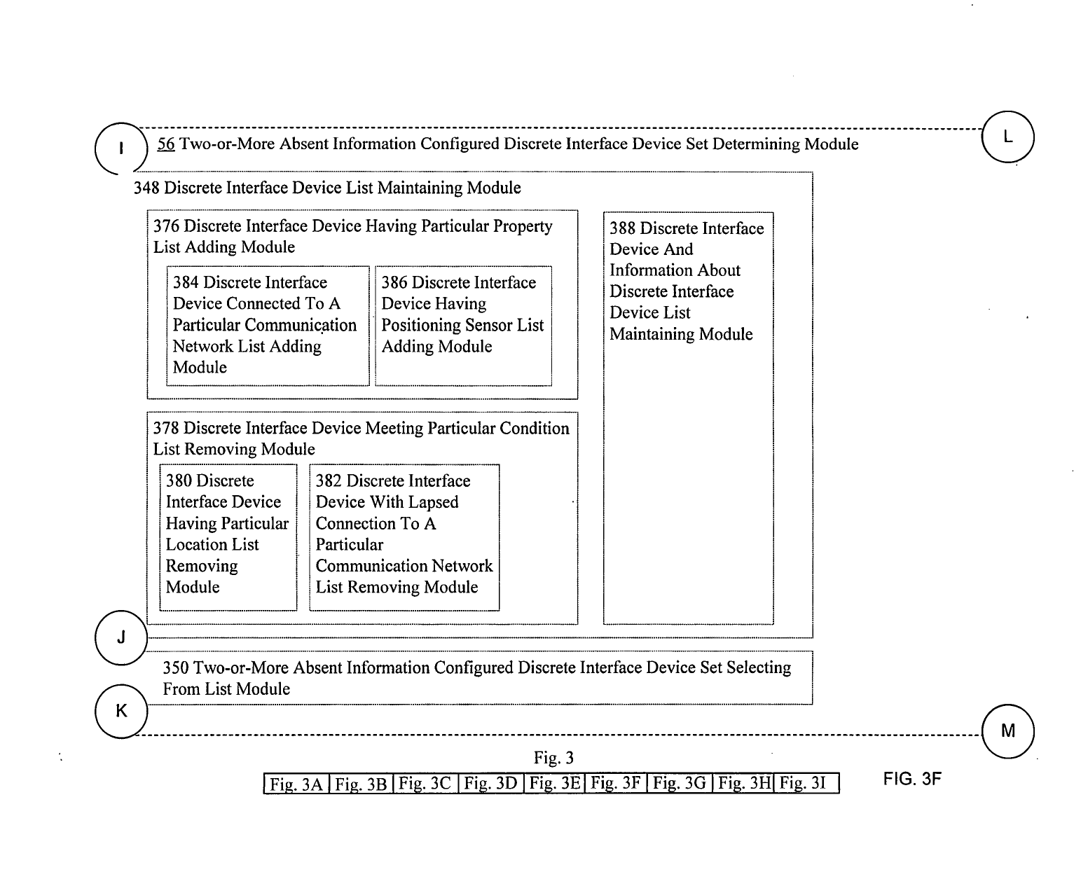

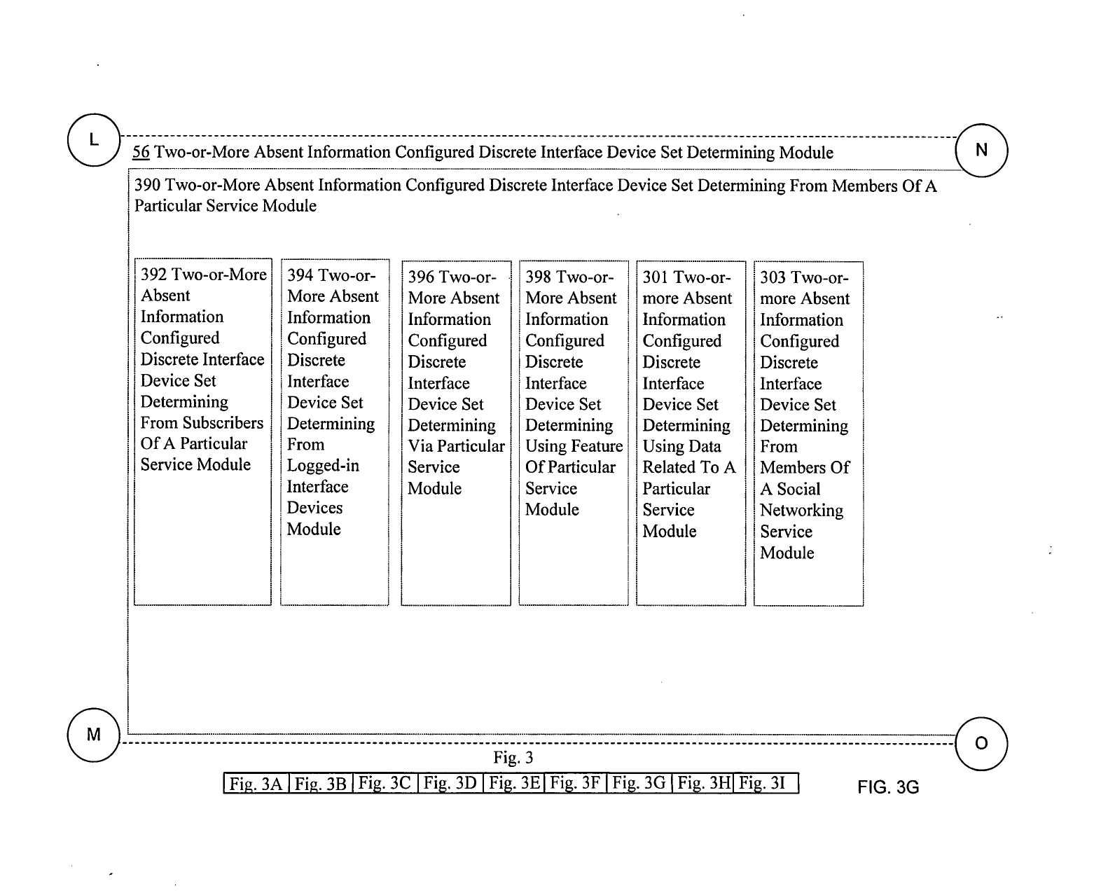

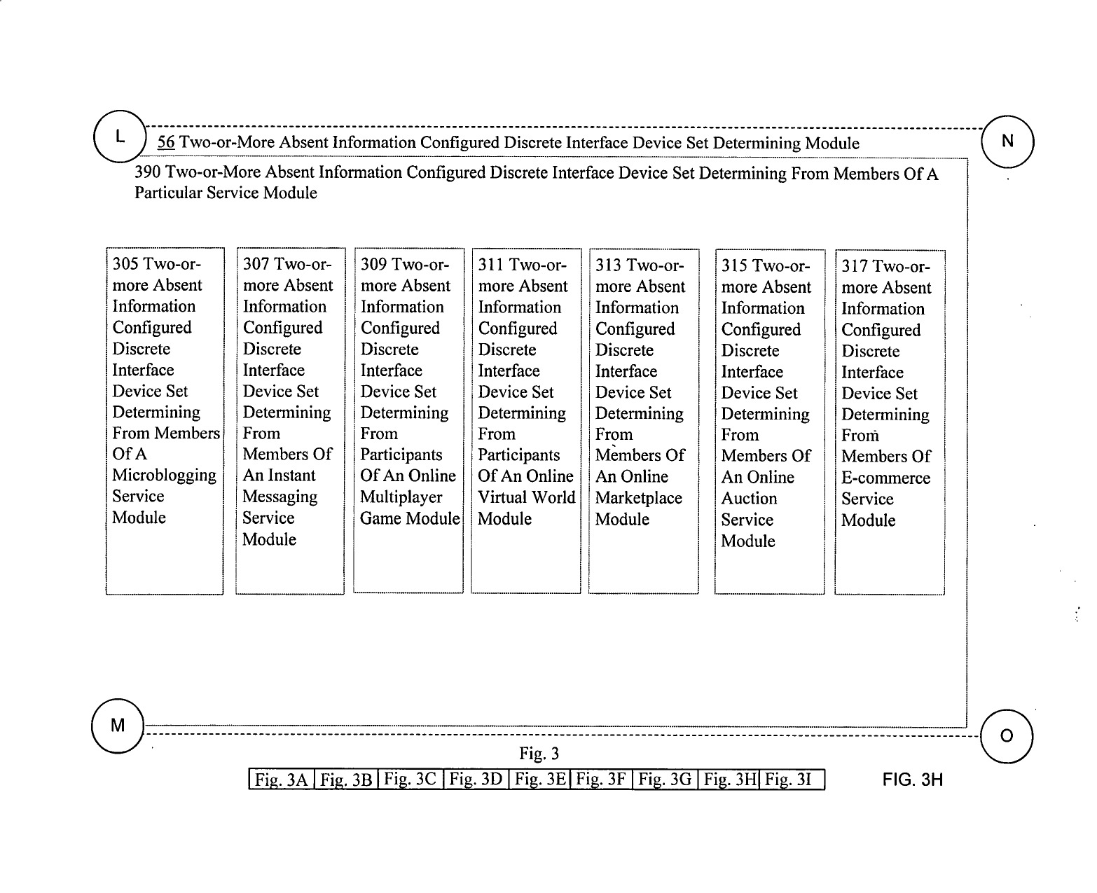

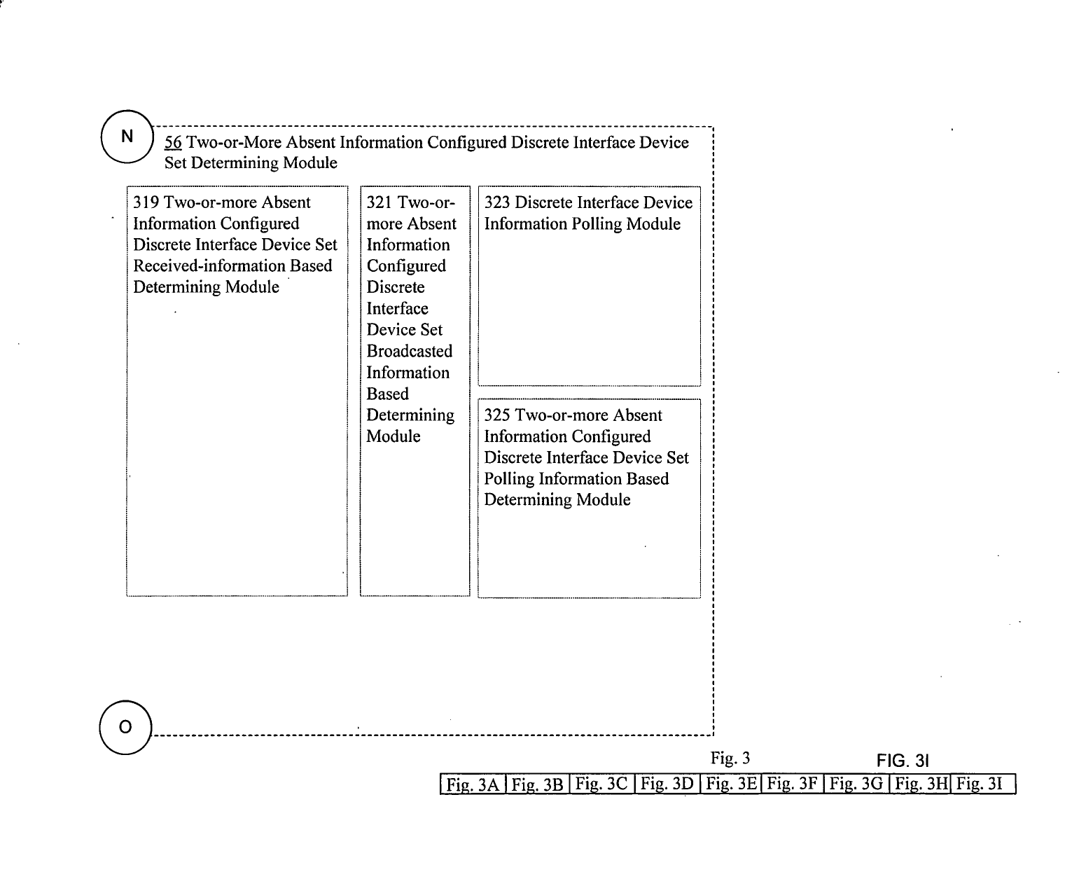

Referring now to FIG. 3, FIG. 3 illustrates an exemplary implementation of two-or-more absent information configured discrete interface device set determining module 56. As illustrated in FIG. 3, the two-or-more absent information configured discrete interface device set determining module 56 may include one or more sub-logic modules in various alternative implementations and embodiments. For example, in some embodiments, module 56 may include two-or-more incomplete information configured discrete interface device set determining module 302, two-or-more less information configured discrete interface device set determining module 304, two-or-more insufficient information configured discrete interface device set determining module 306, two or more absent task information configured discrete interface device set determining module 308, and two-or-more absent task requestor information configured discrete interface device set determining module 310.

In some embodiments, module 56 may include two-or-more absent information configured discrete interface device completion capability determining module 312 (e.g., which may, in some embodiments, include two-or-more absent information configured discrete interface device completion capability for particular communication network determining module 314 and two-or-more absent information configured discrete interface device completion capability for particular property determining module 316), two-or-more absent information configured discrete interface device set determining at request receiving time module 318, two-or-more absent information configured discrete interface device set determining at request executing time module 320, two-or-more absent information configured discrete interface device set determining at predetermined post-request time module 322, and two-or-more absent information configured discrete interface device set list selecting module 324.

In some embodiments, module 56 may include two-or-more absent information configured discrete interface device set determining by obtaining discrete interface device information module 326, e.g., which may, in some embodiments, include two-or-more discrete interface device information obtaining and set determining module 328, two-or-more discrete interface device set determining by obtaining information from particular subscriber service module 330, and two-or-more discrete interface device set determining by obtaining information from communication network module 332.

In some embodiments, module 56 may include two-or-more absent information configured discrete interface device set property-based determining module 334. In some embodiments, module 334 may include two-or-more absent information configured discrete interface device set status-based determining module 336 (e.g., which, in some embodiments, may include two-or-more absent information configured discrete interface device set environment-dependent property-based determining module 338 and two-or-more absent information configured discrete interface device set list-of-statuses-based determining module 340) and two-or-more absent information configured discrete interface device set characteristic-based determining module 342 (e.g., which, in some embodiments, may include two-or-more absent information configured discrete interface device set environment-independent property-based determining module 344 and two-or-more absent information configured discrete interface device set list-of-characteristics-based determining module 346.

In some embodiments, module 56 may include discrete interface device list maintaining module 348 and two-or-more absent information configured discrete interface device set selecting from list module 350. Module 348 may, in some embodiments, include discrete interface device particular interval information receiving module 352. Module 348 may, in some embodiments, include discrete interface device information receiving module 354 (e.g., which, in some embodiments, may include discrete interface device property information receiving module 372 (e.g., which, in some embodiments, may include discrete interface device status and/or characteristic information receiving module 374)) and discrete interface device list updating module 356 (e.g., which, in some embodiments, may include discrete interface device predetermined interval list updating module (e.g., which, in some embodiments, may include discrete interface device one-hour interval list updating module 360 and discrete interface device thirty-second interval list updating module 362), discrete interface device list updating on information receipt module 364, discrete interface device list updating on access module (e.g., which, in some embodiments, may include discrete interface device list information updating on information receipt module 368), and discrete interface device list information particular interval updating module 370.

In some embodiments, module 348 of module 56 may further include discrete interface having particular property list adding module 376 (e.g., which, in some embodiments, may include discrete interface device connected to a particular communication network list adding module 384 and discrete interface device having positioning sensor list adding module 386) and discrete interface device meeting particular condition list removing module 378 (e.g., which, in some embodiments, may include discrete interface device having particular location list removing module 380 and discrete interface device with lapsed connection to a particular communication network list removing module 382), and discrete interface device and information about discrete interface device list maintaining module 388.

In some embodiments, module 56 may include two-or-more absent information configured discrete interface device set determining from members of a particular service module 390. Module 390 may include two-or-more absent information configured discrete interface device set determining from subscribers of a particular service module 392, two-or-more absent information configured discrete interface device set determining from logged-in interface devices module 394, two-or-more absent information configured discrete interface device set determining via particular service module 396, two-or-more absent information configured discrete interface device set determining using feature of particular service module 398, two-or-more absent information configured discrete interface device set determining using data related to a particular service module 301, and two-or-more absent information configured discrete interface device set determining from members of a social networking service module 303.

In some embodiments, two-or-more absent information configured discrete interface device set determining from members of a particular service module 390 of module 56 may include two-or-more absent information configured discrete interface device set determining from members of a microblogging service module 305, two-or-more absent information configured discrete interface device set determining from members of an instant messaging service module 307, two-or-more absent information configured discrete interface device set determining from participants of an online multiplayer game module 309, two-or-more absent information configured discrete interface device set determining from participants of an online virtual world module 311, two-or-more absent information configured discrete interface device set determining from members of an online marketplace module 313, two-or-more absent information configured discrete interface device set determining from members of an online auction service module 315, and two-or-more absent information configured discrete interface device set determining from members of e-commerce service module 317.

In some embodiments, module 56 may include two-or-more absent information configured discrete interface device set received-information based determining module 319, two-or-more absent information configured discrete interface device set broadcasted information based determining module 321, discrete interface device information polling module 323, and two-or-more absent information configured discrete interface device set polling information based determining module 325.

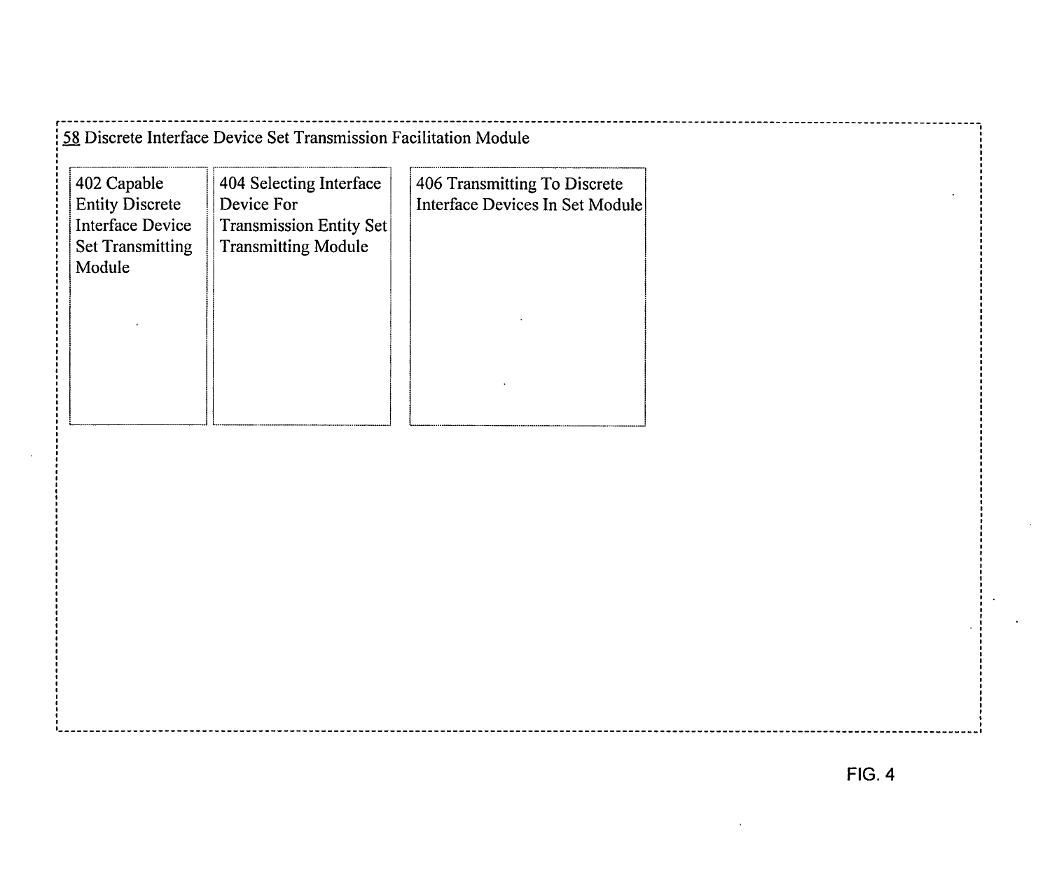

Referring now to FIG. 4, FIG. 4 illustrates an exemplary implementation of the discrete interface device set transmission facilitation module 58. As illustrated in FIG. 4, module 48 may include capable entity discrete interface device set transmitting module 402, selecting interface device for transmission entity set transmitting module 404, and transmitting to discrete interface devices in set module 406.

A more detailed discussion related to computing device 30 of FIG. 1 now will be provided with respect to the processes and operations to be described herein. Referring now to FIG. 5, FIG. 5 illustrates an operational flow 500 representing example operations for, among other methods, receiving a request to carry out a task of acquiring data requested by a task requestor, acquiring one or more subtasks related to the task of acquiring data, determining a set of two or more discrete interface devices that are configured to carry out the one or more subtasks at a particular time and in an absence of information regarding the at least one task and/or the task requestor, and facilitating a transmission of one or more subtasks to two or more of the set of two or more discrete interface devices. In FIG. 5 and in the following figures that include various examples of operational flows, discussions and explanations will be provided with respect to the exemplary environment 100 as described above and as illustrated in FIG. 1, and with respect to other examples (e.g., as provided in FIGS. 2-4) and contexts. It should be understood that the operational flows may be executed in a number of other environments and contexts, and/or in modified versions of the systems shown in FIGS. 2-4. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Referring again to FIG. 5, FIG. 5 shows operation 500 that may include operation 502 depicting receiving a request to carry out a task of acquiring data requested by a task requestor. For example, FIG. 1 shows a task of acquiring data request receiving module 52 receiving a request to carry out a task of acquiring data (e.g., “take a 360-degree near-real-time picture of the Eiffel Tower”) requested by a task requestor (e.g., a user of an iPad connected to a wireless network in Washington, D.C.).

Referring again to FIG. 5, operation 500 may include operation 504 depicting acquiring one or more subtasks related to the task of acquiring data. For example, FIG. 1 shows a related subtask acquiring module 54 acquiring one or more subtasks (e.g., “take a picture of the Eiffel Tower while facing west”) related to the task of acquiring data (e.g, the subtask of “take a picture of the Eiffel Tower while facing west” is part of a number of subtasks that will be completed to facilitate completion of the task of acquiring data, e.g., “take a 360-degree near-real-time picture of the Eiffel Tower.”).

Referring again to FIG. 5, operation 500 may include operation 506 depicting determining a set of two or more discrete interface devices that are configured to carry out the one or more subtasks at a particular time and in an absence of information regarding the at least one task and/or the task requestor. For example, FIG. 1 shows two-or-more discrete interface device set determining module 56 determining a set of two or more discrete interface devices (e.g., an iPhone that is equipped with a camera, a Nokia E5 equipped with a camera, an ASUS EeePc equipped with a webcam, and an ACER Iconia Tablet with a dual camera) that are configured to carry out the one or more subtasks (e.g., have a camera, or, in another example, are in the vicinity of the Eiffel Tower) at a particular time (e.g., at the current moment) and in an absence of information regarding the at least one task and/or the task requestor (e.g., the set of interface devices, when carrying out the subtask, would not know what the task of acquiring data is, only that, at most, they are to take a picture of the Eiffel Tower. In some embodiments, they may be instructed only to activate the image capturing component at a particular time or when the device is oriented in a particular direction. For example, the ASUS EeePc may activate its webcamera when its user is sitting in an outdoor coffee shop in view of the Eiffel Tower, without knowing for what reason it has activated the webcamera, or, in some embodiments, even that it has activated the webcamera).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

Referring again to FIG. 5, operation 500 may include operation 508 depicting facilitating a transmission of one or more subtasks to two or more of the set of two or more discrete interface devices. For example, FIG. 1 shows discrete interface device set transmission facilitation module 58 facilitating a transmission (e.g., performing some act which assists in transmitting, e.g., providing information or providing a list or set of interface devices to a subtask transmitting entity) of one or more subtasks (e.g., “take a picture of the Eiffel Tower from your location”) to two or more of the set of two or more discrete interface devices (e.g., the iPhone and the Nokia E5) of the set of two or more discrete interface devices (e.g., an iPhone that is equipped with a camera, a Nokia E5 equipped with a camera, an ASUS EeePc equipped with a webcam, and an ACER Iconia Tablet with a dual camera). For example, the list of interface devices may be transmitted to a network provider, e.g., AT&T, which may transmit to the AT&T compatible devices, e.g., the iPhone and the Nokia E5.

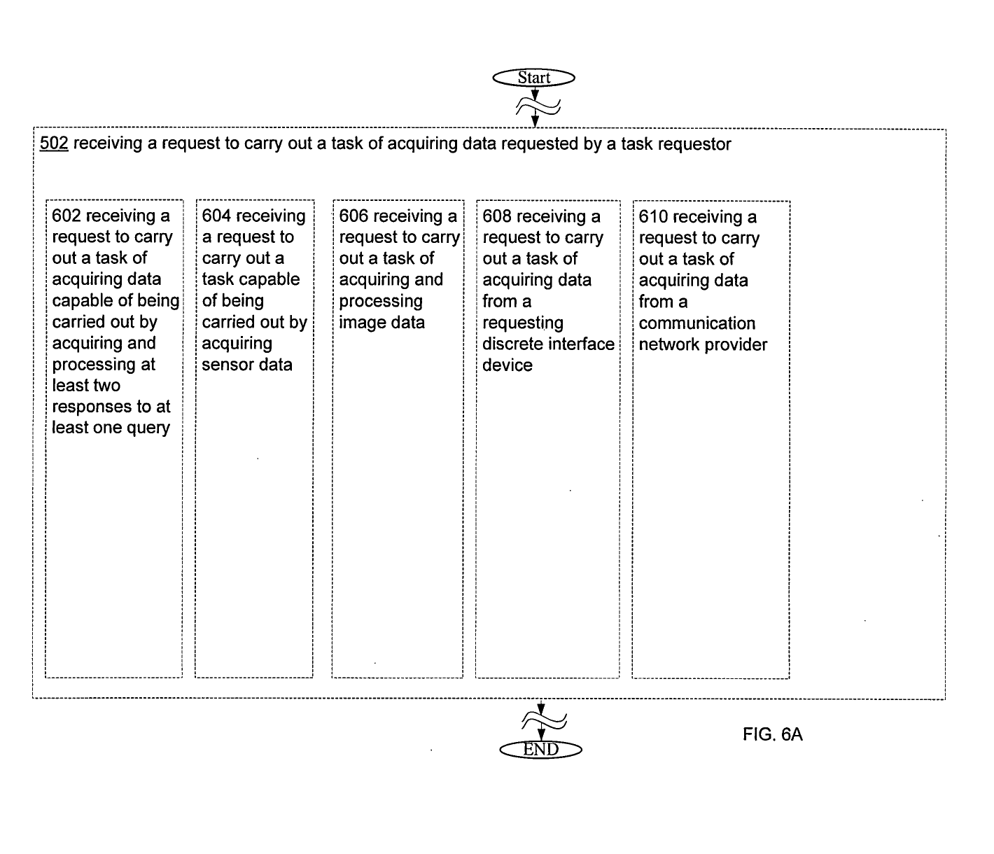

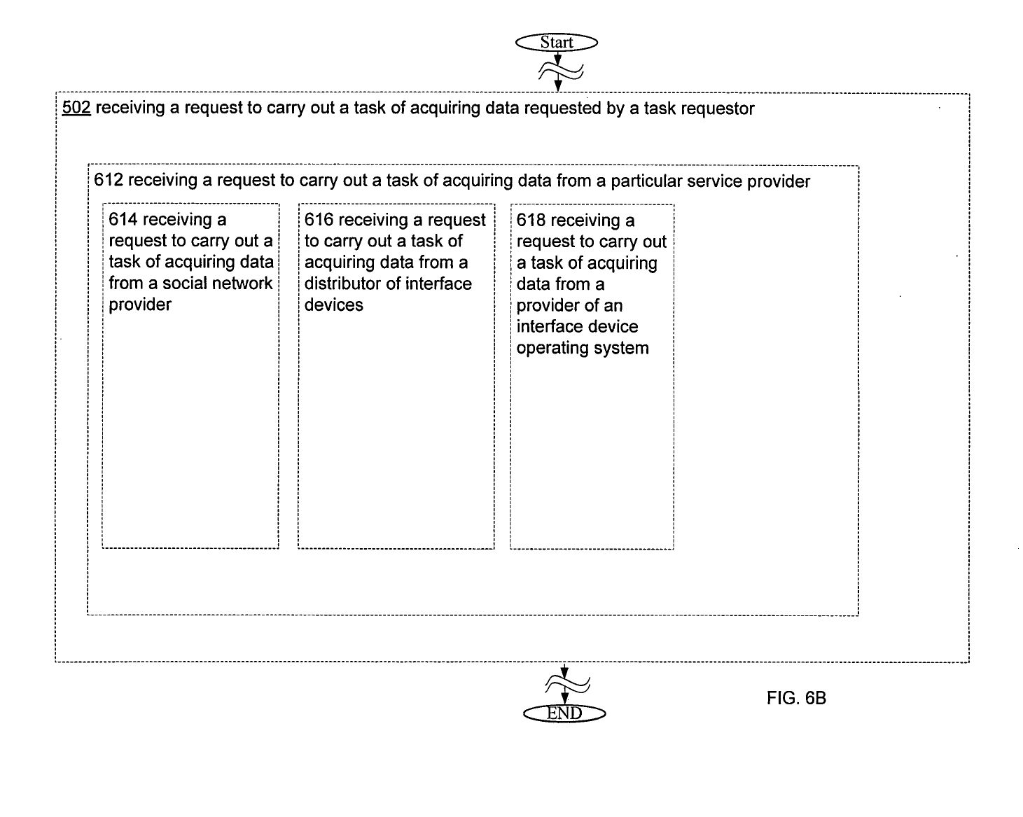

FIGS. 6A-6C depict various implementations of operation 502, according to embodiments. Referring now to FIG. 6A, operation 502 may include operation 602 depicting receiving a request to carry out a task of acquiring data capable of being carried out by acquiring and processing at least two responses to at least one query. For example, FIG. 2A shows task of acquiring data carried out by acquiring at least two query responses request receiving module 202 receiving a request to carry out a task of acquiring data (e.g., “determine which bagel shop in Old Town Alexandria has the freshest bagels”) capable of being carried out by acquiring and processing at least two responses to at least one query (e.g., “how fresh is the bagel you bought at your current location,” sent to at least two people determined to be located in bagel shops).

Referring again to FIG. 6A, operation 502 may include operation 604 depicting receiving a request to carry out a task capable of being carried out by acquiring sensor data. For example, FIG. 2A shows task of acquiring sensor data request receiving module 204 receiving a request to carry out a task of acquiring data (e.g., “take a 360 degree near-real time picture of Times Square”) capable of being carried out by acquiring sensor data (e.g., capturing images from 50 interface devices being used at times square currently, and stitching the photographs together into a 360 degree near-real time picture).

Referring again to FIG. 6A, operation 502 may include operation 606 depicting receiving a request to carry out a task of acquiring and processing image data. For example, FIG. 2 shows task of acquiring and processing image data request receiving module 206 receiving a request to carry out a task (e.g., determine which seat at Merriweather Post Pavillion has an unobstructed view of the stage set up for the U2 concert) of acquiring (e.g., receiving the image data from multiple interface devices determined to be located at various parts of the Merriweather Post Pavillion) and processing (e.g., determining which images represent an unobstructed view of the stage) image data.

Referring again to FIG. 6A, operation 502 may include operation 608 depicting receiving a request to carry out a task of acquiring data from a requesting discrete interface device. For example, FIG. 2A shows task of acquiring data request from discrete interface device receiving module 208 receiving a request to carry out a task of acquiring data (e.g., “determine how bad traffic is on the south branch of I-495”) from a requesting discrete interface device (e.g., a Blackberry of a user on the western portion of I-495, trying to determine whether to detour off of the road or stay on to arrive at the south branch, who sends a request for a task of acquiring data).

Referring again to FIG. 6A, operation 502 may include operation 610 depicting receiving a request to carry out a task of acquiring data from a communication network provider. For example, FIG. 2A shows task of acquiring data request from communication network provider receiving module 210 receiving a request to carry out a task of acquiring data (e.g., “determine which parts of Clarendon, Va. have the fastest 4G upload speeds”) from a communication network provider (e.g., Verizon Wireless, which provides the 4G LTE network in certain areas of the United States).

Referring now to FIG. 6B, operation 502 may include operation 612 depicting receiving a request to carry out a task of acquiring data from a particular service provider. For example, FIG. 2A shows task of acquiring data request from particular service provider receiving module 212 receiving a request to carry out a task of acquiring data (e.g., “determine how many people are going to the Nationals game tonight to watch Stephen Strasburg pitch”) from a particular service provider (e.g., Facebook).

Referring again to FIG. 6B, operation 612 may include operation 614 depicting receiving a request to carry out a task of acquiring data from a social network provider. For example, FIG. 2A shows task of acquiring data request from social network provider receiving module 214 receiving a request to carry out a task of acquiring data (e.g., “determine how many people currently located in the DuPont Circle area of Washington, D.C. have tickets to see the band Dogsprot on December 22”) from a social network provider (e.g., MySpace).

Referring again to FIG. 6B, operation 612 may include operation 616 depicting receiving a request to carry out a task of acquiring data from a distributor of interface devices. For example, FIG. 2A shows task of acquiring data request from interface device distributor receiving module 216 receiving a request to carry out a task of acquiring data (e.g., “how many pictures are on the average smartphone located in Arlington, Va.”) from a distributor of interface devices (e.g., Samsung).

Referring again to FIG. 6B, operation 612 may include operation 618 depicting receiving a request to carry out a task of acquiring data from a provider of an interface device operating system. For example, FIG. 2A shows task of acquiring data request from interface device operating system provider receiving module 218 receiving a request to carry out a task of acquiring data (e.g., “determine which movie theater within walking distance of the U.S. Capitol has the shortest line to buy tickets right now”) from a provider (e.g., Hewlitt-Packard) of an interface device operating system (e.g., PalmOS”)

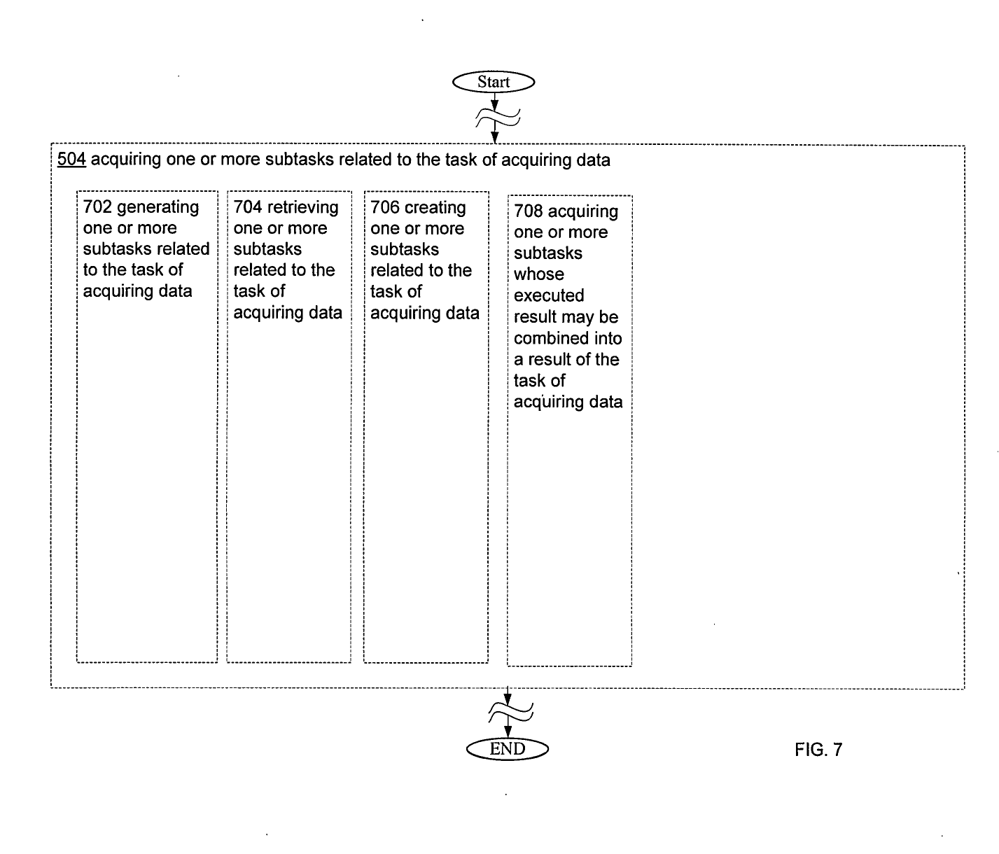

FIG. 7 depicts various embodiments of operation 504 as shown in FIG. 5. Referring again to FIG. 7, operation 504 may include operation 702 depicting generating one or more subtasks related to the task of acquiring data. For example, FIG. 2B shows related subtask generating module 220 generating (e.g., using processors or human-assisted logic to create) one or more subtasks (e.g., “respond to a query regarding a length of the line in which you are currently standing”) related to the task of acquiring data (e.g., “determine which McDonald's drive thru that is a right turn off I-90 that has the shortest line”).

Referring again to FIG. 7, operation 504 may include operation 704 depicting retrieving one or more subtasks related to the task of acquiring data. For example, FIG. 2B shows related subtask retrieving module 222 retrieving (e.g., obtaining from a different location, e.g., in a local or remote memory) one or more subtasks (e.g., “activate the air quality sensor”) related to the task of acquiring data (“determine the exact pollen count right now at Arlington National Cemetery”).

Referring again to FIG. 7, operation 504 may include operation 706 depicting creating one or more subtasks related to the task of acquiring data. For example, FIG. 2B shows related subtask creating module 224 creating (e.g., applying logic rules and artificial or human intelligence to create without relying on retrieving old subtasks) one or more subtasks (e.g., “measure the wireless network signal strength at your location”) related to the task of acquiring data (e.g., “determine which Starbucks has the best wireless network connection today”).

Referring again to FIG. 7, operation 504 may include operation 708 depicting acquiring one or more subtasks whose executed result may be combined into a result of the task of acquiring data. For example, FIG. 2B shows related subtask as combinable portion of task acquiring module 226 acquiring one or more subtasks (e.g., “for interface devices in proximity to Times Square, activate the image capturing sensor”) whose executed result (e.g., “pictures of Times Square”) may be combined into a result (e.g., a 360 degree near-real time picture) of the task of acquiring data (e.g., “acquire a 360 degree near-real time picture of Times Square”).

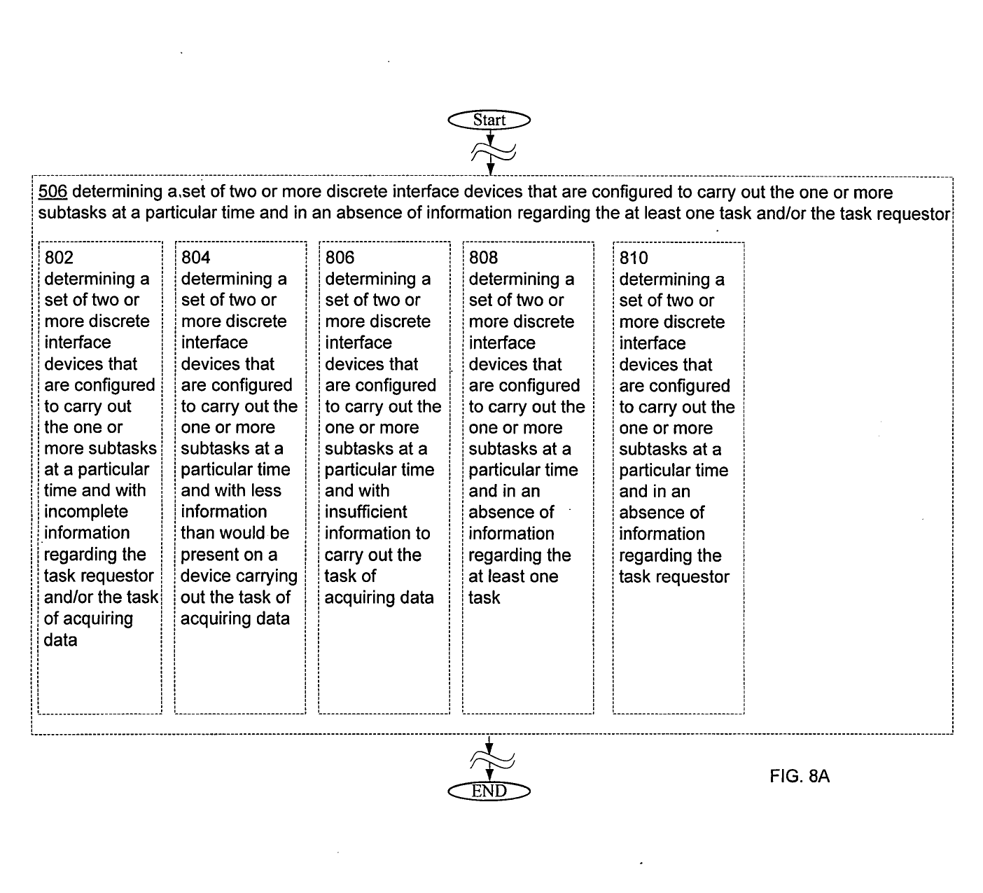

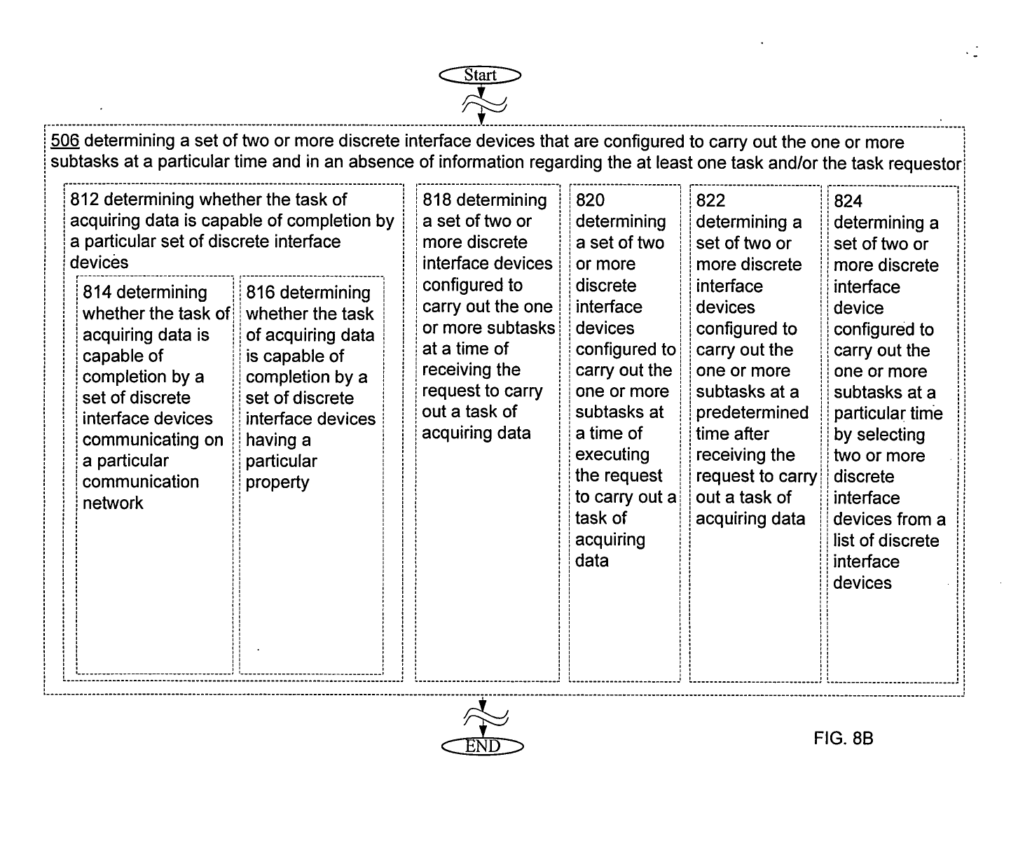

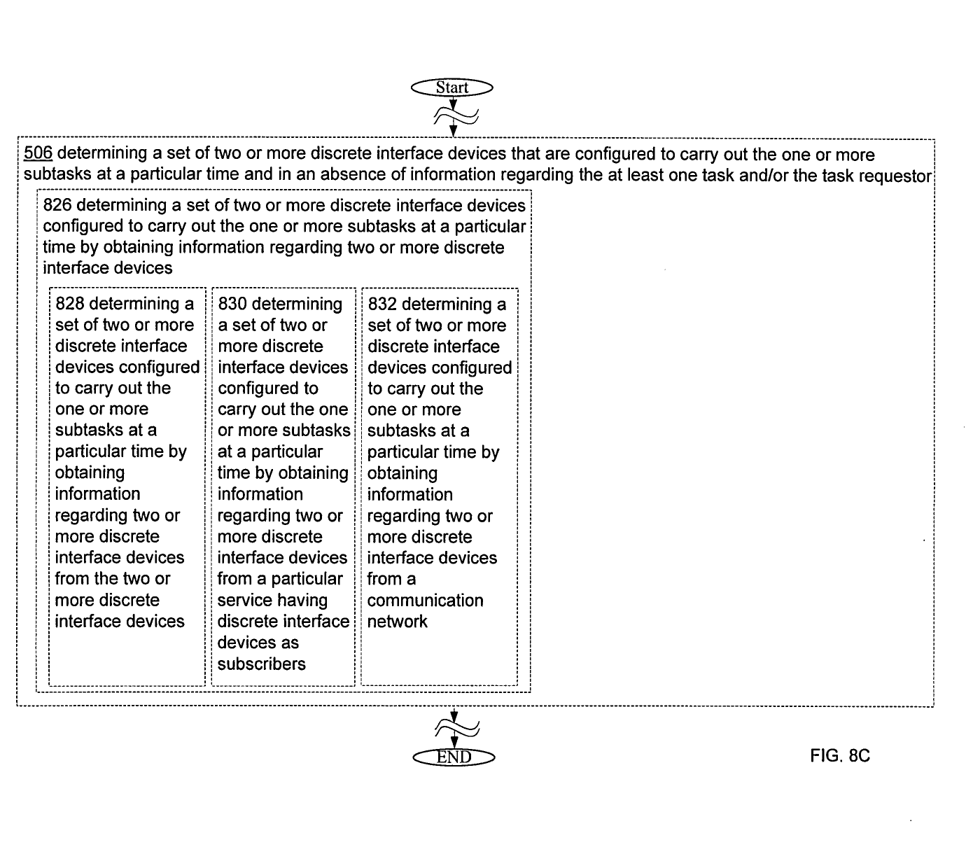

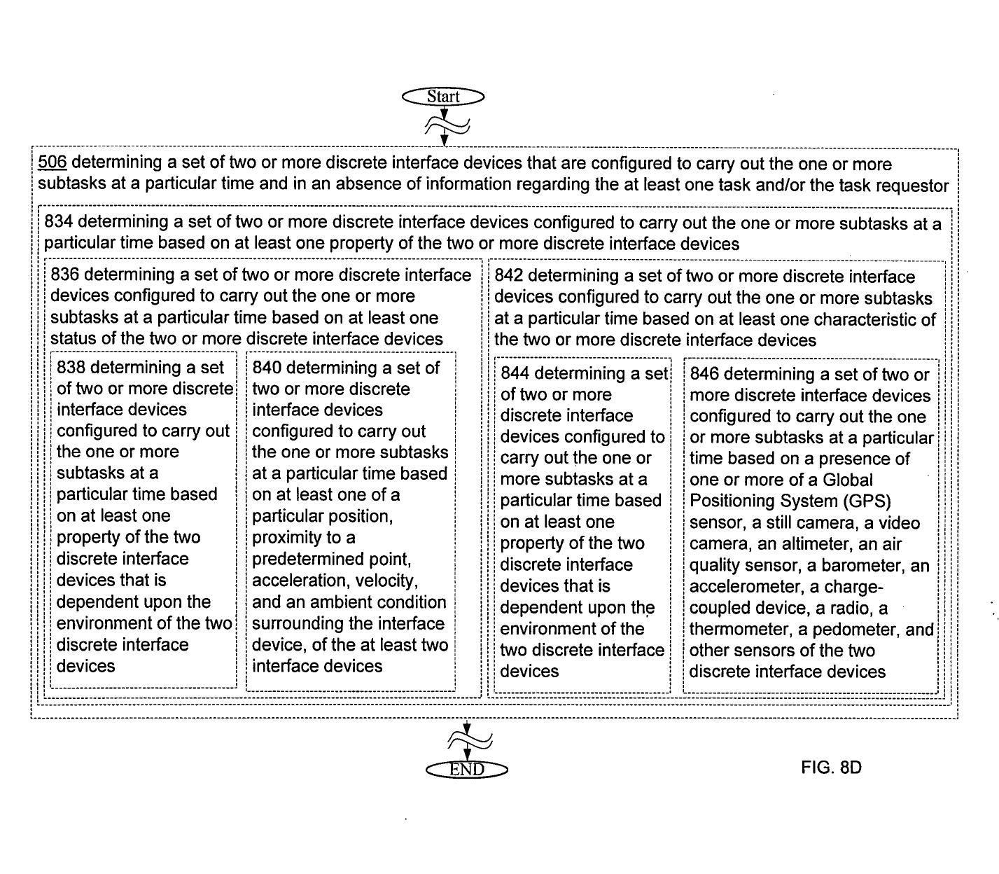

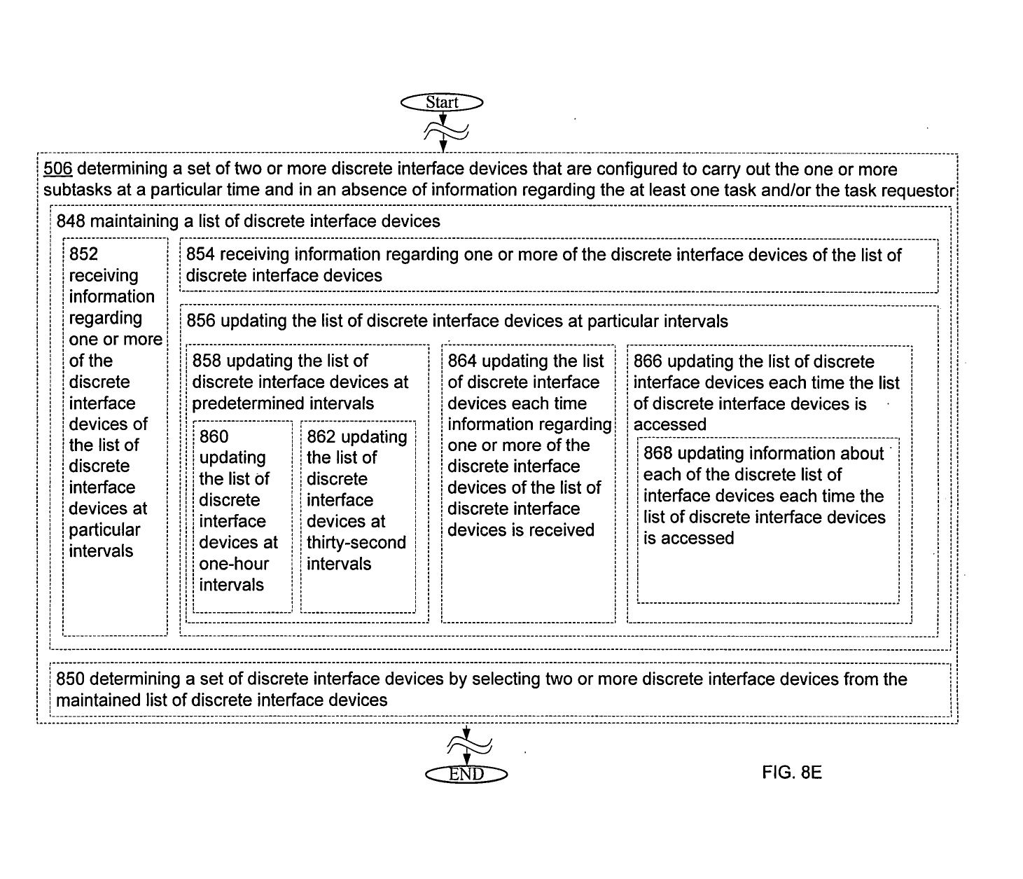

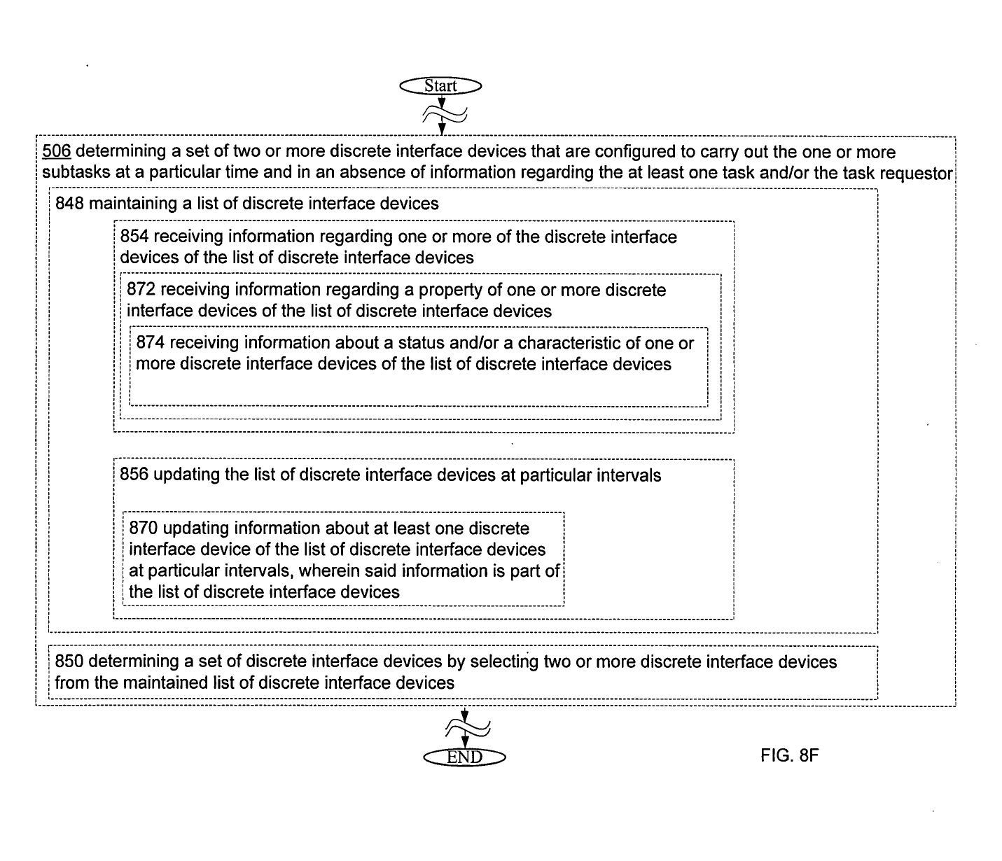

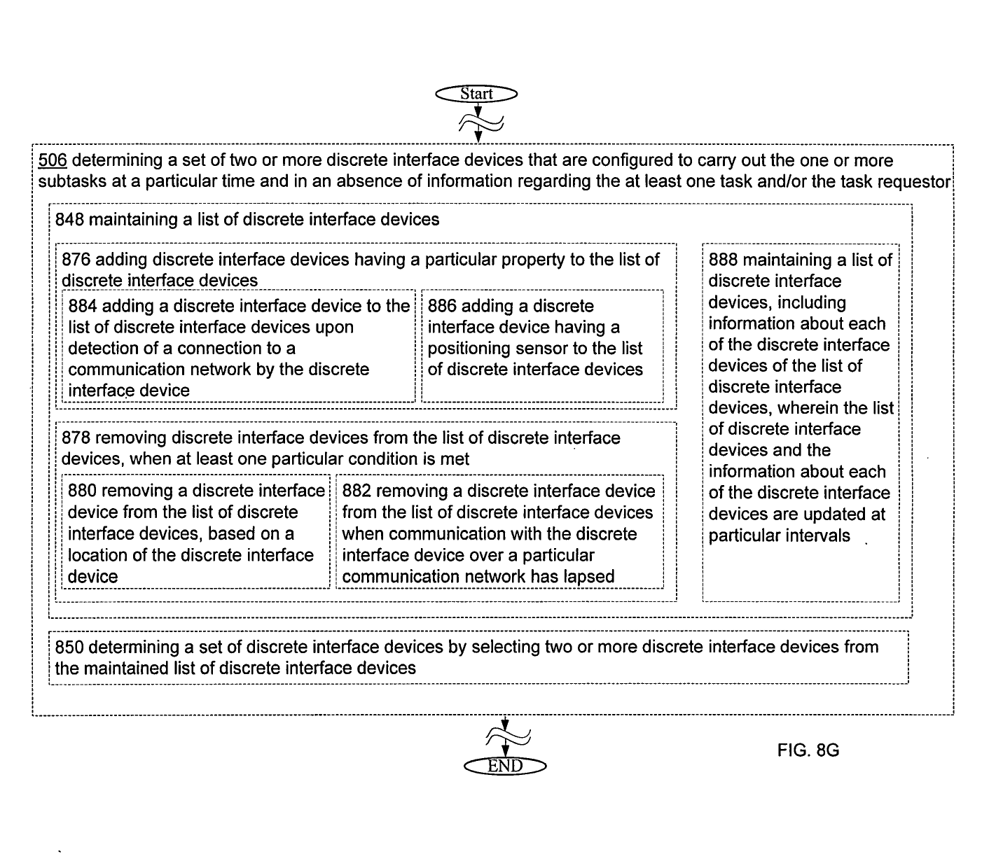

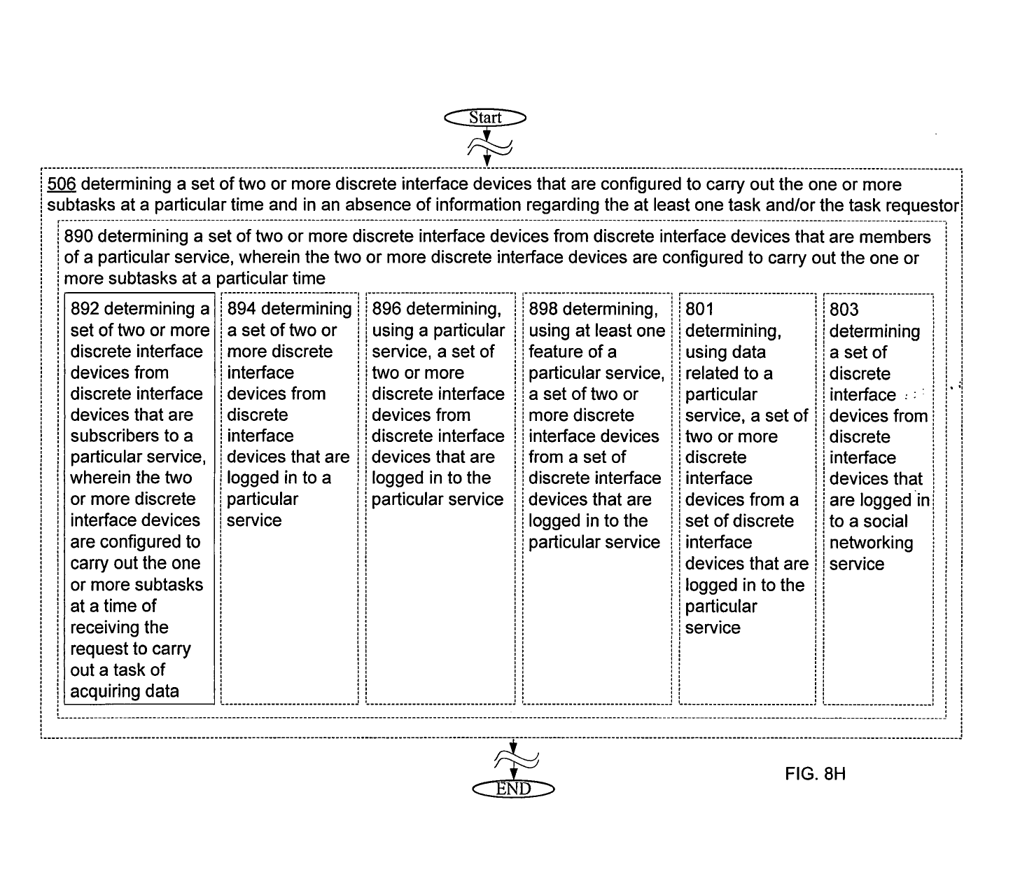

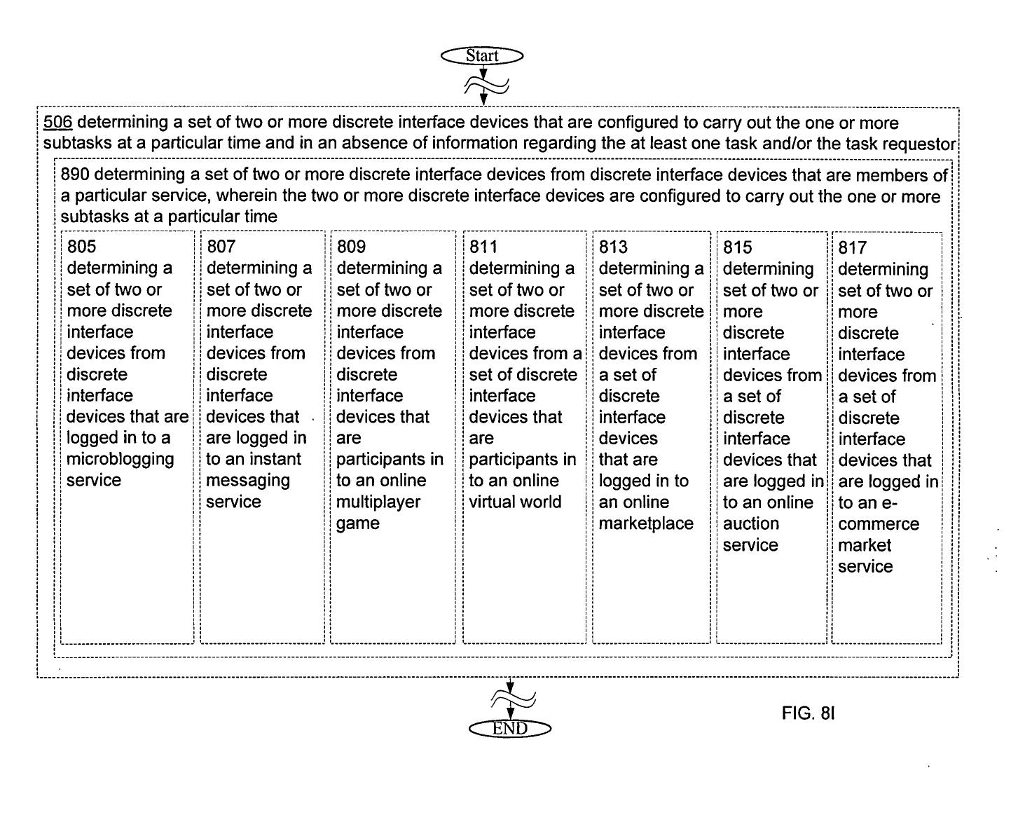

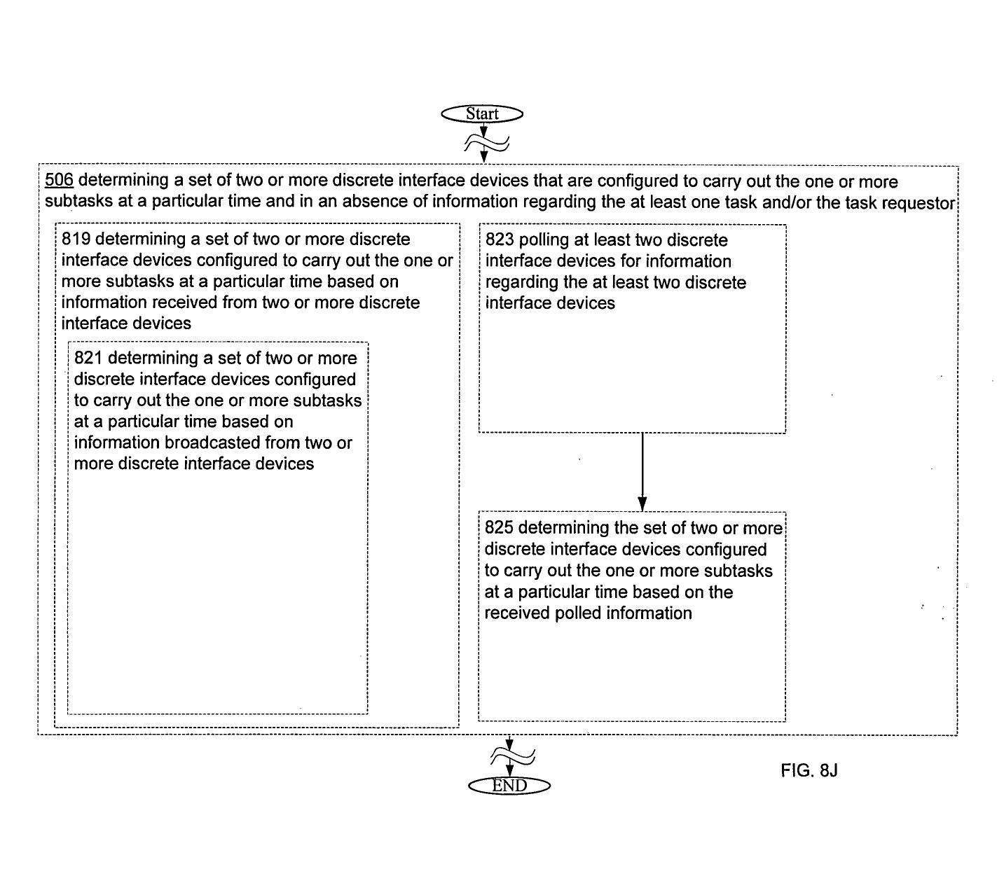

FIGS. 8A-8J depict various embodiments of operation 506. Referring now to FIG. 8A, operation 506 may include operation 802 depicting determining a set of two or more discrete interface devices that are configured to carry out the one or more subtasks at a particular time and with incomplete information regarding the task requestor and/or the task of acquiring data. For example, FIG. 3 shows two-or-more incomplete information configured discrete interface device set determining module 302 determining a set of two or more discrete interface devices (e.g., an Apple iPhone and a BlackBerry 8800) that are configured to carry out the one or more subtasks (e.g., “determine how fast you are moving across the I-90 bridge at your location”) at a particular time (e.g., the current time, or the time of the next Washington Nationals game”) and with incomplete information (e.g., the Apple iPhone and the BlackBerry 8800 do not know the identity of the task requestor or the type of entity, e.g., personal, corporate, automated) and/or the task of acquiring data (e.g., the task of “determine the fastest way into Seattle at 4:25 PM from Bellevue, Wash.,” the iPhone and the Nokia E5 do not know the task, and whether it is “determine the fastest way,” or “monitor traffic conditions,” or any details about how the information the devices are gathering will be used, and to answer which queries).

Referring again to FIG. 8A, operation 506 may include operation 804 depicting determining a set of two or more discrete interface devices that are configured to carry out the one or more subtasks at a particular time and with less information than would be present on a device carrying out the task of acquiring data. For example, FIG. 3 shows two-or-more less information configured discrete interface device set determining module 304 determining a set of two or more discrete interface devices (e.g., a Samsung Galaxy II and a Motorola Droid 3) that are configured to carry out the one or more subtasks (e.g., “determine the view from your location at Safeco field”) at a particular time and with less information than would be present on a device carrying out the task of acquiring data data (e.g., the Samsung Galaxy II and the Droid 3 only activate their image collecting component and collect data. The task is “determine how full the rows are in the upper deck at Safeco Field.” The devices have no idea whether they are capturing images of the fans in the stands, of the view, of the weather, of the sunlight, or of the best time to avoid shadows, or to determine whether the seats are covered. In contrast, a device carrying out the task by itself (which would have to go to each row of the park) would know to determine how full the rows are because of knowledge of the task).

Referring again to FIG. 8A, operation 506 may include operation 806 depicting determining a set of two or more discrete interface devices that are configured to carry out the one or more subtasks at a particular time and with insufficient information to carry out the task of acquiring data. For example, FIG. 3 shows two-or-more insufficient information configured discrete interface device set determining module 306 determining a set of two or more discrete interface devices (e.g., a Droid Revolution and a Nokia E650 smartphone) that are configured to carry out the one or more subtasks (e.g., “determine the wireless network strength at McDonald's in Bellevue, Wash.) at a particular time and with with insufficient information to carry out the task of acquiring data (e.g., the task of acquiring data is “determine which McDonald's of the ones in Bellevue, Wash., have the fastest interne connection.” The interface devices have insufficient information to complete this task because they are merely measuring wireless strength at McDonald's. They do not know whether to measure strength at various McDonald's, various types of signal strength at that McDonald's (e.g., cellular network strength), whether to measure the signal strength at a particular time, or over a particular period of time. The Droid Revolution and the Nokia E650 have insufficient information to carry out the entire task, but are capable of carrying out the subtask that was transmitted to them).

Referring again to FIG. 8A, operation 506 may include operation 808 depicting determining a set of two or more discrete interface devices that are configured to carry out the one or more subtasks at a particular time and in an absence of information regarding the at least one task. For example, FIG. 3 shows two-or-more absent task information configured discrete interface device set determining module 308 determining a set of two or more discrete interface devices (e.g., Samsung Epic Touch smartphone, HTC Evo smartphone) that are configured to carry out the one or more subtasks (e.g., “take a picture of Times Square”) at a particular time (e.g., 8:01:32 a.m.) and in an absence of information regarding the at least one task (e.g., the task is “take a 360-degree picture of Times Square when the new Reebok ad pops up at 8:01:32 a.m.,” and the discrete interface devices do not have the information that this is the task).

Referring again to FIG. 8A, operation 506 may include operation 810 depicting determining a set of two or more discrete interface devices that are configured to carry out the one or more subtasks at a particular time and in an absence of information regarding the task requestor. For example, FIG. 3 shows two-or-more absent task requestor information configured discrete interface device set determining module 310 determining a set of two or more discrete interface devices (e.g., Samsung Epic Touch smartphone, HTC Evo smartphone) that are configured to carry out the one or more subtasks (e.g., “take a picture of Times Square”) at a particular time (e.g., 8:01:32 a.m.) and in an absence of information regarding the at least one task requestor (e.g., the task is “take a 360-degree picture of Times Square when the new Reebok ad pops up at 8:01:32 a.m.,” and the task requestor is Reebok, and the discrete interface devices do not have the information regarding the task requestor, e.g., identity, or which type, e.g., corporate or personal, human or machine query).

Referring now to FIG. 8B, operation 506 may include operation 812 depicting determining whether the task of acquiring data is capable of completion by a particular set of discrete interface devices. For example, FIG. 3 shows two-or-more absent information configured discrete interface device completion capability determining module 312 determining whether the task of acquiring data (e.g., “determine the pollen count on Cherry Blossom Drive in Washington, D.C.”) is capable of completion (e.g., determine whether interface devices 1) have an air quality sensor and 2) are positioned at the proper location, e.g., on or near Cherry Blossom Drive) by a particular set of discrete interface devices (e.g., a provided list of discrete interface devices, or interface devices that are currently in communication, or interface devices that have indicated that they will perform subtasks, or interface devices determined to be on or near Cherry Blossom Drive).

Referring again to FIG. 8B, operation 812 may include operation 814 depicting determining whether the task of acquiring data is capable of completion by a set of discrete interface devices communicating on a particular communication network. For example, FIG. 3 shows two-or-more absent information configured discrete interface device completion capability for particular communication network determining module 314 determining whether the task of acquiring data (e.g., “determine whether the barometric pressure is dropping at your location”) is capable of completion by a set of discrete interface devices (e.g., do the discrete interface devices have a barometer”) communicating on a particular communication network (e.g., the 4G LTE network).

Referring again to FIG. 8B, operation 812 may include operation 816 depicting determining whether the task of acquiring data is capable of completion by a set of discrete interface devices having a particular property. For example, FIG. 3 shows two-or-more absent information configured discrete interface device completion capability for particular property determining module 316 determining whether the task of acquiring data (e.g., “determine whether your seat at Verizon Center for the Washington Capitals has a view of the opposing goalie”) is capable of completion by a set of discrete interface devices (e.g., discrete interface devices determined to be located within the Verizon Center) having a particular property (e.g., located within the Verizon Center).

Referring again to FIG. 8B, operation 506 may include operation 818 depicting determining a set of two or more discrete interface devices configured to carry out the one or more subtasks at a time of receiving the request to carry out a task of acquiring data. For example, FIG. 3 shows two-or-more absent information configured discrete interface device set determining at request receiving time module 318 determining a set of two or more discrete interface devices (e.g., creating or generating a set, e.g., a list, database, or other data structure, of discrete interface devices) configured to carry out the one or more subtasks (e.g., “activate the image capturing sensor and determine how many people appear in the captured image”) at a time of receiving the request to carry out a task of acquiring data (e.g., “determine the total number of people in Wal-Mart right now”).

Referring again to FIG. 8B, operation 506 may include operation 820 depicting determining a set of two or more discrete interface devices configured to carry out the one or more subtasks at a time of executing the request to carry out a task of acquiring data. For example, FIG. 3 shows two-or-more absent information configured discrete interface device set determining at request executing time module 320 determining a set of two or more discrete interface devices (e.g., creating or generating a set, e.g., a list, database, or other data structure, of discrete interface devices) configured to carry out the one or more subtasks (e.g., “activate the image capturing sensor”) at a time of executing the request (e.g., taking steps to carry out the request) to carry out a task of acquiring data (e.g., “determine the total number of people in Target at 9:05 am on Thursday”).

Referring again to FIG. 8B, operation 506 may include operation 822 depicting determining a set of two or more discrete interface devices configured to carry out the one or more subtasks at a predetermined time after receiving the request to carry out a task of acquiring data. For example, FIG. 3 shows two-or-more absent information configured discrete interface device set determining at predetermined post-request time module 322 determining a set of two or more discrete interface devices (e.g., creating or generating a set, e.g., a list, database, or other data structure, of discrete interface devices) configured to carry out the one or more subtasks (e.g., “determine your speed over the next 30 minutes”) at a predetermined time (e.g., thirty minutes) after receiving the request to carry out a task of acquiring data (e.g., “determine how bad the traffic on the George Washington Bridge is at 8:35 am today”).

Referring again to FIG. 8B, operation 506 may include operation 824 depicting determining a set of two or more discrete interface devices configured to carry out the one or more subtasks at a particular time by selecting two or more discrete interface devices from a list of discrete interface devices. For example, FIG. 3 shows two-or-more absent information configured discrete interface device set list selecting module 324 determining a set of two or more discrete interface devices (e.g., creating or generating a set, e.g., a list, database, or other data structure, of discrete interface devices) configured to carry out the one or more subtasks (e.g., “determine how much sunlight is reaching your location at the current time”) at a particular time by selecting two or more discrete interface devices (e.g., discrete interface devices that have a camera, e.g., an iPhone 4, and a Samsung Galaxy tablet) from a list of discrete interface devices (e.g., a list of devices, either subscribers to a service, or visible devices on a network, or any list, either partially retrieved, fully retrieved, or retrieved as needed, or created or generated, from any location).

Referring now to FIG. 8C, operation 506 may include operation 826 depicting determining a set of two or more discrete interface devices configured to carry out the one or more subtasks at a particular time by obtaining information regarding two or more discrete interface devices. For example, FIG. 3 shows two-or-more absent information configured discrete interface device set determining by obtaining discrete interface device information module determining a set of two or more discrete interface devices (e.g., creating or generating a set, e.g., a list, database, or other data structure, of discrete interface devices) configured to carry out the one or more subtasks (e.g., “determine a number of WPA encrypted wireless networks visible at your present location”) at a particular time by obtaining information (e.g., whether a discrete interface device has a wireless radio) regarding two or more discrete interface devices (e.g., a BlackBerry 8000, a Samsung Galaxy SII, and an Apple iPad, where the BlackBerry 8000 can communicate over a cellular network but does not have a wireless radio, and thus would not be included in the set of discrete interface devices).

Referring again to FIG. 8C, operation 826 may include operation 828 depicting determining a set of two or more discrete interface devices configured to carry out the one or more subtasks at a particular time by obtaining information regarding two or more discrete interface devices from the two or more discrete interface devices. For example, FIG. 3 shows two-or-more discrete interface device information obtaining and set determining module 328 determining a set of two or more discrete interface devices (e.g., creating or generating a set, e.g., a list, database, or other data structure, of discrete interface devices) configured to carry out the one or more subtasks (e.g., measure the loudness level at the restaurant at your present location”) at a particular time by obtaining information (e.g., by receiving information regarding whether a device has an omnidirectional microphone) regarding two or more discrete interface devices (e.g., a Sony recorder, an Apple iPhone, a Pantech Breakout) from the two or more discrete interface devices (e.g., each of the Sony recorder, Apple iPhone, and Pantech Breakout provide the information regarding whether they have an omnidirectional microphone).

Referring again to FIG. 8C, operation 826 may include operation 830 depicting determining a set of two or more discrete interface devices configured to carry out the one or more subtasks at a particular time by obtaining information regarding two or more discrete interface devices from a particular service having discrete interface devices as subscribers. For example, FIG. 3 shows two-or-more discrete interface device set determining by obtaining information from particular subscriber service module 330 determining a set of two or more discrete interface devices (e.g., creating or generating a set, e.g., a list, database, or other data structure, of discrete interface devices) configured to carry out the one or more subtasks at a particular time (e.g., measuring ambient street noise at 7 am in particular neighborhoods) by obtaining information (e.g., whether the interface devices are usually at particular neighborhoods at 7 am) from a particular service (e.g., facebook) having discrete interface devices as subscribers (e.g., the discrete interface device, through user logins and cookies, is known to the particular service provider).

Referring again to FIG. 8C, operation 826 may include operation 832 depicting determining a set of two or more discrete interface devices configured to carry out the one or more subtasks at a particular time by obtaining information regarding two or more discrete interface devices from a communication network. For example, FIG. 3 shows two-or-more discrete interface device set determining by obtaining information from communication network module 332 determining a set of two or more discrete interface devices (e.g., creating or generating a set, e.g., a list, database, or other data structure, of discrete interface devices) configured to carry out the one or more subtasks (e.g., “determine the exact time of sunset at your particular location”) at a particular time by obtaining information (e.g., a location of an interface device) regarding two or more discrete interface devices (e.g., a Sony Xperioa and a Nokia Lumia) from a communication network (e.g., Verizon Wireless, e.g., by determining locations of discrete interface devices through cellular tower triangulation).

Referring again to FIG. 8C, operation 826 may include operation 834 depicting determining a set of two or more discrete interface devices configured to carry out the one or more subtasks at a particular time based on at least one property of the two or more discrete interface devices. For example, FIG. 3 shows two-or-more absent information configured discrete interface device set property-based determining module 334 determining a set of two or more discrete interface devices (e.g., creating or generating a set, e.g., a list, database, or other data structure, of discrete interface devices) configured to carry out the one or more subtasks (e.g., “determine how many double chocolate donuts are remaining at the Krispy Kreme at your location”) at a particular time based on at least one property (e.g., location, or proximity to a Krispy Kreme donuts) of the two or more discrete interface devices (e.g., a Pantech Pocket and a Samsung Focus S).

Referring now to FIG. 8D, operation 834 may include operation 836 depicting determining a set of two or more discrete interface devices configured to carry out the one or more subtasks at a particular time based on at least one status of the two or more discrete interface devices. For example, FIG. 3 shows two-or-more absent information configured discrete interface device set status-based determining module 336 determining a set of two or more discrete interface devices (e.g., creating or generating a set, e.g., a list, database, or other data structure, of discrete interface devices) configured to carry out the one or more subtasks (e.g., “take a picture of the Eiffel Tower”) at a particular time based on at least one status (e.g., proximity to the Eiffel Tower) of the two or more discrete interface devices (e.g., an HTC Sensation 4G and an HTC Amaze 4G).

Referring again to FIG. 8D, operation 836 may include operation 838 depicting determining a set of two or more discrete interface devices configured to carry out the one or more subtasks at a particular time based on at least one property of the two discrete interface devices that is dependent upon the environment of the two or more discrete interface devices. For example, FIG. 3 shows two-or-more absent information configured discrete interface device set environment-dependent property-based determining module 338 determining a set of two or more discrete interface devices (e.g., creating or generating a set, e.g., a list, database, or other data structure, of discrete interface devices) configured to carry out the one or more subtasks (e.g., “respond to a query regarding the length of the line to get into the movie theater that you are currently standing in”) at a particular time based on at least one property (e.g., movement speed) of the two discrete interface devices (e.g., Motorola Droid Razr and T-Mobile MyTouch Slide) that is dependent upon the environment (e.g., the movement speed of the Razr and the MyTouch) of the two discrete interface devices.

Referring again to FIG. 8D, operation 836 may include operation 840 depicting determining a set of two or more discrete interface devices configured to carry out the one or more subtasks at a particular time based on at least one of a particular position, proximity to a predetermined point, acceleration, velocity, and an ambient condition surrounding the interface device, of the at least two interface devices. For example, FIG. 3 shows two-or-more absent information configured discrete interface device set list-of-statuses-based determining module 340 determining a set of two or more discrete interface devices (e.g., creating or generating a set, e.g., a list, database, or other data structure, of discrete interface devices) configured to carry out the one or more subtasks (e.g., “take a picture of the Space Needle”) at a particular time based on at least one of a particular position, proximity to a predetermined point, acceleration, velocity, and an ambient condition surrounding the interface device, of the at least two interface devices (e.g., a Motorola Brute and a BlackBerry Bold).

Referring again to FIG. 8D, operation 834 may include operation 842 depicting determining a set of two or more discrete interface devices configured to carry out the one or more subtasks at a particular time based on at least one characteristic of the two or more discrete interface devices. For example, FIG. 3 shows two-or-more absent information configured discrete interface device set characteristic-based determining module 342 determining a set of two or more discrete interface devices (e.g., creating or generating a set, e.g., a list, database, or other data structure, of discrete interface devices) configured to carry out the one or more subtasks (e.g., “determine the loudness at the Pearl Jam concert from particular spots at Key Arena”) at a particular time based on at least one characteristic (e.g., type of microphone) of the two or more discrete interface devices (e.g., Sony Digital Recorder and Nokia E7 smartphone).

Referring again to FIG. 8D, operation 842 may include operation 844 depicting determining a set of two or more discrete interface devices configured to carry out the one or more subtasks at a particular time based on at least one property of the two discrete interface devices that is independent from the environment of the two or more discrete interface devices. For example, FIG. 3 shows two-or-more absent information configured discrete interface device set environment-independent property-based determining module 344 determining a set of two or more discrete interface devices (e.g., creating or generating a set, e.g., a list, database, or other data structure, of discrete interface devices) configured to carry out the one or more subtasks (e.g., “determine the view of the third trumpeter at the London Philharmonic from various seats at the Kennedy Center”) at a particular time based on at least one property of the two discrete interface devices (e.g., the presence or absence of a rear-facing camera) that is independent from the environment (e.g., the presence or absence of a rear-facing camera does not change) of the two or more discrete interface devices (e.g., the Apple iPhone 4 and the BlackBerry Playbook).

Referring again to FIG. 8D, operation 842 may include operation 846 depicting determining a set of two or more discrete interface devices configured to carry out the one or more subtasks at a particular time based on a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor of the two or more discrete interface devices. For example, FIG. 3 shows two-or-more absent information configured discrete interface device set list-of-characteristics-based determining module 346 determining a set of two or more discrete interface devices (e.g., creating or generating a set, e.g., a list, database, or other data structure, of discrete interface devices) configured to carry out the one or more subtasks (e.g., “take a picture of the Washington Monument”) based on a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor of the two discrete interface devices (e.g., an Asus Transformer and an HTC Evo View).

Referring now to FIG. 8E, operation 506 may include operation 848 depicting maintaining a list of discrete interface devices. For example, FIG. 3 shows discrete interface device list maintaining module 348 maintaining (e.g., keeping, updating, or having access to) a list (e.g., a list, a database, or any other data structure, either permanent or non-permanent) of discrete interface devices (e.g., Apple iPhone, Samsung Epic Touch, HP Touchpad, Microsoft Zune, Sandisk Sansa Clip+, Kodak Playsport).

Referring again to FIG. 8E, operation 506 may include operation 850 depicting determining a set of discrete interface devices by selecting two or more discrete interface devices from the maintained list of discrete interface devices. For example, FIG. 3 shows two-or-more absent information configured discrete interface device set selecting from list module 350 determining a set of discrete interface devices (e.g., creating or generating a set, e.g., a list, database, or other data structure, of discrete interface devices) by selecting two or more discrete interface devices (e.g., Sansa Clip+ and Kodak Playsport) from the maintained list of discrete interface devices (e.g., Apple iPhone, Samsung Epic Touch, HP Touchpad, Microsoft Zune, Sandisk Sansa Clip+, Kodak Playsport).

Referring again to FIG. 8E, operation 848 may include operation 852 depicting receiving information regarding one or more of the discrete interface devices of the list of discrete interface devices at particular intervals. For example, FIG. 3 shows discrete interface device particular interval information receiving module 352 receiving information (e.g., position information, sensor statuses, or data from sensors) regarding one or more of the discrete interface devices (e.g., Apple iPhone 4) of the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at particular intervals (e.g., every five minutes, or each time a triggering event occurs, the particular intervals may or may not be the same length).

Referring again to FIG. 8E, operation 848 may include operation 854 depicting receiving information regarding one or more of the discrete interface devices of the list of discrete interface devices. For example, FIG. 3 shows discrete interface device information receiving module 354 receiving information (e.g., cellular signal strength information) regarding one or more of the discrete interface devices (e.g., Samsung Epic Touch) of the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others).

Referring again to FIG. 8E, operation 848 also may include operation 856 depicting updating the list of discrete interface devices at particular intervals. For example, FIG. 3 shows discrete interface device list updating module 356 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at particular intervals (e.g., regular intervals, e.g., every five minutes, or irregular intervals, e.g., after a triggering event, and not necessarily of the same length).

Referring again to FIG. 8E, operation 856 may include operation 858 depicting updating the list of discrete interface devices at predetermined intervals. For example, FIG. 3 shows discrete interface device predetermined interval list updating module 358 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at predetermined intervals (e.g., although not necessarily the same length, intervals that have a known length, as opposed to being started by triggering events, e.g., every five minutes, e.g., every five minutes in odd hours, and every ten minutes in even hours, or every thirty seconds for five minutes, then nothing for an hour, then every forty-five seconds for five minutes, then nothing for forty-five minutes).

Referring again to FIG. 8E, operation 858 may include operation 860 depicting updating the list of discrete interface devices at one-hour intervals. For example, FIG. 3 shows discrete interface device one-hour interval list updating module 360 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at one-hour intervals (e.g., updating the list every sixty minutes, e.g., for lists that do not require regular up-to-the-minute updating).

Referring again to FIG. 8E, operation 858 may include operation 862 depicting updating the list of discrete interface devices at thirty-second intervals. For example, FIG. 3 shows discrete interface device thirty-second interval list updating module 362 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at thirty-second intervals (e.g., lists that may require updated information, e.g., lists including approximate locations of discrete interface devices).

Referring again to FIG. 8E, operation 856 may include operation 864 depicting updating the list of discrete interface devices each time information regarding one or more of the discrete interface devices of the list of discrete interface devices is received. For example, FIG. 3 shows discrete interface device list updating on information receipt module 364 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) each time information (e.g., position information) regarding one or more of the discrete interface devices (e.g., HP Touchpad) from the list of discrete interface devices is received (e.g., either by request, or by information that is broadcasted, or information that is retrieved from a database or other location).

Referring again to FIG. 8E, operation 856 may include operation 866 depicting updating the list of discrete interface devices each time the list of discrete interface devices is accessed. For example, FIG. 3 shows discrete interface device list updating on access module 366 updating the list (e.g., adding or removing discrete interface devices from the list, and adding, removing, or changing any information that is kept with the list of discrete interface devices) of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) each time the list of discrete interface devices is accessed (e.g., each time information that is on the list is read, retrieved, or changed).

Referring again to FIG. 8E, operation 866 may include operation 868 depicting updating information about the list of discrete interface devices each time the list of discrete interface devices is accessed. For example, FIG. 3 shows discrete interface device list information updating on information receipt module 368 updating information (e.g., ambient temperature information) about the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) each time the list of discrete interface devices is accessed (e.g., each time information that is on the list is read, retrieved, or changed).

Referring now to FIG. 8F, operation 856 may include operation 870 depicting updating information about at least one discrete interface device of the list of discrete interface devices at particular intervals, wherein said information is part of the list of discrete interface devices. For example, FIG. 3 shows discrete interface device list information particular interval updating module 370 updating information (e.g., wireless network presence information) about at least one discrete interface device (e.g., the Microsoft Zune) of the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) at particular intervals (e.g., regular intervals, e.g., every five minutes, or irregular intervals, e.g., after a triggering event, and not necessarily of the same length), wherein said information is part of the list of discrete interface devices (e.g., the wireless network presence information is kept and maintained with the list of discrete interface devices, which can occur in various formats and linking methods, and does not need to be stored in the same physical space or addressing system).

Referring again to FIG. 8F, operation 854 may include operation 872 depicting receiving information regarding a property of one or more discrete interface devices of the list of discrete interface devices. For example, FIG. 3 shows discrete interface device property information receiving module 372 receiving information regarding a property (e.g., a presence of a sensor) of one or more discrete interface devices (e.g., the Microsoft Zune) of the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others).

Referring again to FIG. 8F, operation 872 may include operation 874 depicting receiving information about a status and/or a characteristic of one or more discrete interface devices of the list of discrete interface devices. For example, FIG. 3 shows discrete interface device status and/or characteristic information receiving module 374 receiving information about a status and/or a characteristic (e.g., a proximity to a particular landmark) of one or more discrete interface devices (e.g., HP Touchpad) of the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others).

Referring now to FIG. 8G, operation 848 may include operation 876 depicting adding discrete interface devices having a particular property to the list of discrete interface devices. For example, FIG. 3 shows discrete interface device having particular property list adding module 376 adding discrete interface devices (e.g., changing the list to include discrete interface devices) having a particular property (e.g., has a barometer) to the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others).

Referring again to FIG. 8G, operation 848 may include operation 878 depicting removing discrete interface devices from the list of discrete interface devices, when at least one particular condition is met. For example, FIG. 3 shows discrete interface device meeting particular condition list removing module 378 removing (e.g., changing the list to delete discrete interface devices) discrete interface devices from the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others), when at least one particular condition is met (e.g., the discrete interface device moves away from an area of interest, e.g., away from Times Square).

Referring again to FIG. 8G, operation 878 may include operation 880 depicting removing a discrete interface device from the list of discrete interface devices, based on a location of the discrete interface device. For example, FIG. 3 shows discrete interface device having particular location list removing module 380 removing a discrete interface device (e.g., changing the list to delete the discrete interface device) from the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others), based on a location of the discrete interface device.

Referring again to FIG. 8G, operation 878 may include operation 882 depicting removing a discrete interface device from the list of discrete interface devices when communication with the discrete interface device over a particular communication network has lapsed. For example, FIG. 3 shows discrete interface device with lapsed connection to a particular communication network list removing module 382 removing a discrete interface device (e.g., changing the list to delete a discrete interface device) when communication with the discrete interface device (e.g., the Apple iPhone) over a particular communication network (e.g., AT&T EDGE network) has lapsed (e.g., the discrete interface device has gone out of service).

Referring again to FIG. 8G, operation 878 may include operation 884 depicting adding a discrete interface device to the list of discrete interface devices upon detection of a connection to a communication network by the discrete interface device. For example, FIG. 3 shows discrete interface device connected to a particular communication network list adding module 384 adding a discrete interface device (e.g., changing the list to include an Apple iPad) to the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others) upon detection of a connection to a communication network (e.g., AT&T EDGE network) by the discrete interface device.

Referring again to FIG. 8G, operation 876 may include operation 886 depicting adding a discrete interface device having a positioning sensor to the list of discrete interface devices. For example, FIG. 3 shows discrete interface device having positioning sensor list adding module 386 adding a discrete interface device (e.g., a Motorola Xoom) having a positioning sensor (e.g., a GPS Sensor) to the list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others).

Referring again to FIG. 8G, operation 848 may include operation 888 depicting maintaining a list of discrete interface devices, including information about each of the discrete interface devices of the list of discrete interface devices, wherein the list of discrete interface devices and the information about each of the discrete interface devices are updated at particular intervals. For example, FIG. 3 shows discrete interface device and information about discrete information device list maintaining module 388 maintaining (e.g., keeping, updating, or having access to) a list of discrete interface devices (e.g., Apple iPhone, Samsung Epic Touch, HP Touchpad, Microsoft Zune, Sandisk Sansa Clip+, Kodak Playsport, Asus EeePc, Dell Inspiron 15R, ADT Networked Home Security System, Accuweather Weather Station, Chevy Tahoe with OnStar, TomTom GPS 4100, and others), including information about each of the discrete interface devices (e.g., a list of sensors on each discrete interface devices), wherein the list of discrete interface devices and the information about each of the discrete interface devices are updated at particular intervals (e.g., regular intervals, e.g., every five minutes, or irregular intervals, e.g., after a triggering event, and not necessarily of the same length).

Referring now to FIG. 8H, operation 506 may include operation 890 depicting determining a set of two or more discrete interface devices from discrete interface devices that are members of a particular service, wherein the two or more discrete interface devices are configured to carry out the one or more subtasks at a particular time. For example, FIG. 3 shows two-or-more absent information configured discrete interface device set determining from members of a particular service module 390 determining a set of two or more discrete interface devices (e.g., Apple iPad 2, Apple iPhone) from discrete interface devices that are members of a particular service (e.g., devices that are members of Apple's App Store), wherein the two or more discrete interface devices are configured to carry out the one or more subtasks (e.g., “determine how bad the traffic is at your position in West Seattle”) at a particular time (e.g., currently).

Referring again to FIG. 8H, operation 890 may include operation 892 depicting determining a set of two or more discrete interface devices from discrete interface devices that are subscribers to a particular service, wherein the two or more discrete interface devices are configured to carry out the one or more subtasks at a time of receiving the request to carry out a task of acquiring data. For example, FIG. 3 shows two-or-more absent information configured discrete interface device set determining from subscribers of a particular service module 392 determining a set of two or more discrete interface devices (e.g., ACER Iconia, ASUS Transformer Prime) from discrete interface devices that are subscribers to a particular service (e.g., are members of Google's Android App Store), wherein the two or more discrete interface devices are configured to carry out the one or more subtasks (e.g., “take a picture of the Library of Congress) at a time of receiving the request to carry out a task of acquiring data (e.g., “obtain a near-real time 360-degree picture of the Library of Congress”).

Referring again to FIG. 8H, operation 890 may include operation 894 depicting determining a set of two or more discrete interface devices from discrete interface devices that are logged in to a particular service. For example, FIG. 3 shows two-or-more absent information configured discrete interface device set determining from logged-in interface devices module 394 determining a set of two or more discrete interface devices (e.g., Apple iPhone, Dell Inspiron) from discrete interface devices that are logged in to a particular service (e.g., myspace).

Referring again to FIG. 8H, operation 890 may include operation 896 depicting determining, using a particular service, a set of two or more discrete interface devices from discrete interface devices that are logged in to the particular service. For example, FIG. 3 shows two-or-more absent information configured discrete interface device set determining via particular service module 396 determining, using a particular service (e.g., receiving the information, e.g., status and/or characteristic information, (e.g., location, reputation, or presence of sensors) from Facebook that allows the determination of the set of discrete interface devices) a set of two or more discrete interface devices (e.g., BlackBerry Playbook, HTC EVO Flyer) that are logged in to the particular service (e.g., Facebook).

Referring again to FIG. 8H, operation 890 may include operation 898 depicting determining, using at least one feature of a particular service, a set of two or more discrete interface devices from a set of discrete interface devices that are logged in to the particular service. For example, FIG. 3 shows two-or-more absent information configured discrete interface device set determining using feature of particular service module 396 determining, using at least one feature of a particular service (e.g., Facebook's location updating service) a set of two or more discrete interface devices (e.g., BlackBerry Playbook, HTC EVO Flyer) that are logged in to the particular service (e.g., Facebook).

Referring again to FIG. 8H, operation 890 may include operation 801 depicting determining, using data related to a particular service, a set of two or more discrete interface devices from a set of discrete interface devices that are logged in to the particular service. For example, FIG. 3 shows two-or-more absent information configured discrete interface device set determining using data related to a particular service module 301 determining, using data related to a particular service (e.g., hashtag data on twitter identifying that you are at a Washington Capitals game or are a Washington Capitals fan), a set of two or more discrete interface devices (e.g., an HTC Amaze 4G and a Nokia E5) from a set of discrete interface devices that are logged in to the particular service (e.g., Twitter).

Referring again to FIG. 8H, operation 890 may include operation 803 depicting determining a set of discrete interface devices from discrete interface devices that are logged in to a social networking service. For example, FIG. 3 shows two-or-more absent information configured discrete interface device set determining from members of a social networking service module 303 determining a set (e.g., creating or generating a set, e.g., a list, database, or other data structure, of discrete interface devices) of discrete interface devices from discrete interface devices that are logged into a social networking service (e.g., MySpace).

Referring now to FIG. 8I, operation 890 may include operation 805 depicting determining a set of two or more discrete interface devices from discrete interface devices that are logged in to a microblogging service. For example, FIG. 3 shows two-or-more absent information configured discrete interface device set determining from members of a microblogging service module 305 determining a set (e.g., creating or generating a set, e.g., a list, database, or other data structure, of discrete interface devices) of discrete interface devices from discrete interface devices that are logged into a microblogging service (e.g., Twitter).

Referring again to FIG. 8I, operation 890 may include operation 807 depicting determining a set of two or more discrete interface devices from discrete interface devices that are logged in to an instant messaging service. For example, FIG. 3 shows two-or-more absent information configured discrete interface device set determining from members of an instant messaging service module 307 determining a set (e.g., creating or generating a set, e.g., a list, database, or other data structure, of discrete interface devices) of discrete interface devices from discrete interface devices that are logged into an instant messaging service (e.g., Windows Live Messenger).

Referring again to FIG. 8I, operation 890 may include operation 809 depicting determining a set of two or more discrete interface devices from discrete interface devices that are participants in to an online multiplayer game. For example, FIG. 3 shows two-or-more absent information configured discrete interface device set determining from participants of an online multiplayer game module 309 determining a set (e.g., creating or generating a set, e.g., a list, database, or other data structure, of discrete interface devices) of discrete interface devices from discrete interface devices that are logged into an online multiplayer game (e.g., World of Warcraft).

Referring again to FIG. 8I, operation 890 may include operation 811 depicting determining a set of two or more discrete interface devices from a set of discrete interface devices that are participants in to an online virtual world. For example, FIG. 3 shows two-or-more absent information configured discrete interface device set determining from participants of an online virtual world module 311 determining a set (e.g., creating or generating a set, e.g., a list, database, or other data structure, of discrete interface devices) of discrete interface devices from discrete interface devices that are logged into an online virtual world (e.g., Second Life).

Referring again to FIG. 8I, operation 890 may include operation 813 depicting determining a set of two or more discrete interface devices from a set of discrete interface devices that are logged in to an online marketplace. For example, FIG. 3 shows two-or-more absent information configured discrete interface device set determining from members of an online marketplace module 313 determining a set (e.g., creating or generating a set, e.g., a list, database, or other data structure, of discrete interface devices) of discrete interface devices from discrete interface devices that are logged into an online marketplace (e.g., Amazon Marketplace).

Referring again to FIG. 8I, operation 890 may include operation 815 depicting determining a set of two or more discrete interface devices from a set of discrete interface devices that are logged in to an online auction service. For example, FIG. 3 shows two-or-more absent information configured discrete interface device set determining from members of an online auction service module 315 determining a set (e.g., creating or generating a set, e.g., a list, database, or other data structure, of discrete interface devices) of discrete interface devices from discrete interface devices that are logged into an online auction service (e.g., eBay)

Referring again to FIG. 8I, operation 890 may include operation 817 depicting determining a set of two or more discrete interface devices from a set of discrete interface devices that are logged in to an e-commerce market service. For example, FIG. 3 shows two-or-more absent information configured discrete interface device set determining from members of e-commerce service module 317 determining a set (e.g., creating or generating a set, e.g., a list, database, or other data structure, of discrete interface devices) of discrete interface devices from discrete interface devices that are logged into an e-commerce market service (e.g., ETSY).

Referring now to FIG. 8J, operation 506 may include operation 819 depicting determining a set of two or more discrete interface devices configured to carry out the one or more subtasks at a particular time based on information received from two or more discrete interface devices. For example, FIG. 3 shows two-or-more absent information configured discrete interface device set received-information based determining module 319 determining a set (e.g., creating or generating a set, e.g., a list, database, or other data structure, of discrete interface devices) of two or more discrete interface devices (e.g., a Samsung Galaxy Tab and a Kindle Fire) configured to carry out the one or more subtasks (e.g., “respond to a query regarding the strength of the coffee at the coffee shop at your present location”) at a particular time based on information received from two or more discrete interface devices (e.g., the location information, e.g. whether the device is at a coffee shop, is received from the Galaxy Tab and the Kindle Fire).

Referring again to FIG. 8J, operation 819 may include operation 821 depicting determining a set of two or more discrete interface devices configured to carry out the one or more subtasks at a particular time based on information broadcasted from two or more discrete interface devices. For example, FIG. 3 shows two-or-more absent information configured discrete interface device set broadcasted information based determining module 321 determining a set (e.g., creating or generating a set, e.g., a list, database, or other data structure, of discrete interface devices) of two or more discrete interface devices (e.g., a Nook Color and an Acer Iconia A500) configured to carry out the one or more subtasks (e.g., “respond to a query regarding the freshness of the fruit at the farmer's market at your present location”) at a particular time based on information broadcasted (e.g., location information that is transmitted to the world, e.g., by posting it to Facebook or Twitter) from two or more discrete interface devices.

Referring again to FIG. 8J, operation 819 may include operation 823 depicting polling at least two discrete interface devices for information regarding the at least two discrete interface devices. For example, FIG. 3 shows discrete interface device information polling module 323 polling (e.g., sending a request for something to one or more devices, where the exact number and identity of the devices may be partially known) for information regarding the at least two discrete interface devices (e.g., location information, sensor information, willingness to complete subtasks information).

Referring again to FIG. 8J, operation 819 may include operation 825 depicting determining the set of two or more discrete interface devices configured to carry out the one or more subtasks at a particular time based on the received polled information. For example. FIG. 3 shows two-or-more absent information configured discrete interface device set polling information based determining module 325 determining a set (e.g., creating or generating a set, e.g., a list, database, or other data structure, of discrete interface devices) of two or more discrete interface devices (e.g., a HTC Rezound and a Motorola Brute) configured to carry out the one or more subtasks (e.g., measure the air quality at Rock Creek Park) at a particular time (on Saturday morning at 6 am) based on the received polled information (e.g., devices that have an air quality sensor or are willing to test the air and report back in the form of a query response).

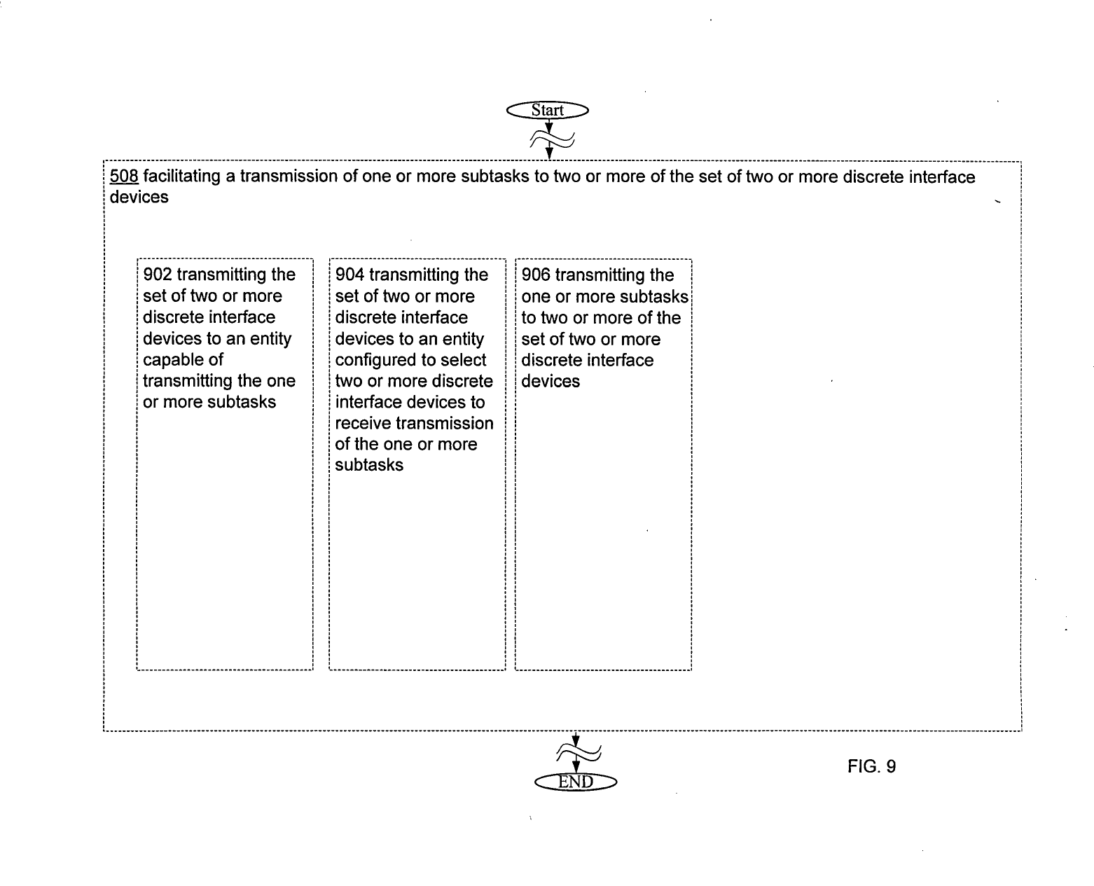

Referring now to FIG. 9, operation 508 may include operation 902 depicting transmitting the set of two or more discrete interface devices to an entity capable of transmitting the one or more subtasks. For example, FIG. 4 shows capable entity discrete interface device set transmitting module 402 transmitting the set of two or more discrete interface devices (e.g., sending the device list, which may include information about the devices) to an entity capable of transmitting the one or more subtasks (e.g., the entity may be an AT&T server, or it may be a Facebook server that can send out a blast to subscribers, or it may be Google, who can post something to Android Market or set an ad in Gmail).

Referring again to FIG. 9, operation 508 may include operation 904 depicting transmitting the set of two or more discrete interface devices to an entity configured to select two or more discrete interface devices to receive transmission of the one or more subtasks. For example, FIG. 4 shows selecting interface device for transmission entity set transmitting module 404 transmitting the set of two or more discrete interface devices (e.g., sending the device list, which may include information about the devices) to an entity configured to select two or more discrete interface devices (e.g. Verizon) to receive transmission of the one or more subtasks (e.g., Verizon may select only such devices that are members of its network, or which subscribe to a preferred (e.g., more profitable) data plan).

Referring again to FIG. 9, operation 508 may include operation 906 depicting transmitting the one or more subtasks to two or more of the set of two or more discrete interface devices. For example, FIG. 4 shows transmitting to discrete interface devices in set module 406 transmitting the one or more subtasks (e.g., “take a picture of your current location”) to two or more of the stet of two or more discrete interface devices (e.g., transmitting the subtasks directly to the discrete interface devices that will carry out the tasks).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. In addition, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-154. (canceled)

155. A system, comprising:
a task of acquiring data request receiving module configured to receive a request to carry out a task of acquiring data requested by a task requestor;
a related subtask acquiring module configured to acquire one or more subtasks related to the task of acquiring data;
a two-or-more absent information configured discrete interface device set determining module configured to determine a set of two or more discrete interface devices that are configured to carry out the one or more subtasks at a particular time and in an absence of information regarding the at least one task and/or the task requestor; and
a discrete interface device set transmission facilitation module configured to facilitate a transmission of one or more subtasks to two or more of the set of two or more discrete interface devices.

156. The system of claim 155, wherein said task of acquiring data request receiving module comprises:
a task of acquiring data carried out by acquiring at least two query responses request receiving module configured to receive a request to carry out a task of acquiring data capable of being carried out by acquiring and processing at least two responses to at least one query.

157. (canceled)

158. (canceled)

159. (canceled)

160. (canceled)

161. The system of claim 155, wherein said task of acquiring data request receiving module comprises:
a task of acquiring data request from particular service provider receiving module configured to receive a request to carry out a task of acquiring data from a social network provider.

162. (canceled)

163. (canceled)

164. The system of claim 161, wherein said task of acquiring data request from particular service provider receiving module comprises:
a task of acquiring data request from interface device operation system provider receiving module configured to receive a request to carry out a task of acquiring data from a provider of an interface device operating system.

165. (canceled)

166. The system of claim 155, wherein said related subtask acquiring module comprises:
a related subtask retrieving module configured to retrieve one or more subtasks related to the task of acquiring data.

167. (canceled)

168. (canceled)

169. The system of claim 155, wherein two-or-more absent information configured discrete interface device set determining module comprises:
a two-or-more incomplete information configured discrete interface device set determining module configured to determine a set of two or more discrete interface devices that are configured to carry out the one or more subtasks at a particular time and with incomplete information regarding the task requestor and/or the task of acquiring data.

170. (canceled)

171. The system of claim 155, wherein two-or-more absent information configured discrete interface device set determining module comprises:
a two-or-more insufficient information configured discrete interface device set determining module configured to determine a set of two or more discrete interface devices that are configured to carry out the one or more subtasks at a particular time and with insufficient information to carry out the task of acquiring data.

172. (canceled)

173. (canceled)

174. The system of claim 155, wherein two-or-more absent information configured discrete interface device set determining module comprises:
a two-or-more absent information configured discrete interface device completion capability determining module configured to determine whether the task of acquiring data is capable of completion by a particular set of discrete interface devices.

175. The system of claim 174, wherein said two-or-more absent information configured discrete interface device completion capability determining module comprises:
a two-or-more absent information configured discrete interface device completion capability for particular communication network determining module configured to determine whether the task of acquiring data is capable of completion by a set of discrete interface devices communicating on a particular communication network.

176. The system of claim 174, wherein said two-or-more absent information configured discrete interface device completion capability determining module comprises:
a two-or-more absent information configured discrete interface device completion capability for particular property determining module configured to determine whether the task of acquiring data is capable of completion by a set of discrete interface devices having a particular property.

177. (canceled)

178. (canceled)

179. The system of claim 155, wherein two-or-more absent information configured discrete interface device set determining module comprises:
a two-or-more absent information configured discrete interface device set determining at predetermined post-request time module configured to determine a set of two or more discrete interface devices configured to carry out the one or more subtasks at a predetermined time after receiving the request to carry out a task of acquiring data.

180. (canceled)

181. The system of claim 155, wherein said two-or-more absent information configured discrete interface device set determining module comprises:
a two-or-more absent information configured discrete interface device set determining by obtaining discrete interface device information module configured to determine a set of two or more discrete interface devices configured to carry out the one or more subtasks at a particular time by obtaining information regarding two or more discrete interface devices.

182. The system of claim 181, wherein said two-or-more absent information configured discrete interface device set determining by obtaining discrete interface device information module comprises:
a two-or-more discrete interface device information obtaining and set determining module configured to determine a set of two or more discrete interface devices configured to carry out the one or more subtasks at a particular time by obtaining information regarding two or more discrete interface devices from the two or more discrete interface devices.

183. The system of claim 181, wherein said two-or-more absent information configured discrete interface device set determining by obtaining discrete interface device information module comprises:
a two-or-more discrete interface device set determining by obtaining information from particular subscriber service module configured to determine a set of two or more discrete interface devices configured to carry out the one or more subtasks at a particular time by obtaining information regarding two or more discrete interface devices from a particular service having discrete interface devices as subscribers.

184. The system of claim 181, wherein said two-or-more absent information configured discrete interface device set determining by obtaining discrete interface device information module comprises:
a two-or-more discrete interface device set determining by obtaining information from communication network module configured to determine a set of two or more discrete interface devices configured to carry out the one or more subtasks at a particular time by obtaining information regarding two or more discrete interface devices from a communication network.

185. The system of claim 155, wherein said two-or-more absent information configured discrete interface device set determining module comprises:
a two-or-more absent information configured discrete interface device set property-based determining module configured to determine a set of two or more discrete interface devices configured to carry out the one or more subtasks at a particular time based on at least one property of the two or more discrete interface devices.

186. The system of claim 185, wherein said two-or-more absent information configured discrete interface device set property-based determining module comprises:
a two-or-more absent information configured discrete interface device set status-based determining module configured to determine a set of two or more discrete interface devices configured to carry out the one or more subtasks at a particular time based on at least one status of the two or more discrete interface devices.

187. (canceled)

188. (canceled)

189. The system of claim 185, wherein said two-or-more absent information configured discrete interface device set property-based determining module comprises:
a two-or-more absent information configured discrete interface device set characteristic-based determining module configured to determine a set of two or more discrete interface devices configured to carry out the one or more subtasks at a particular time based on at least one characteristic of the two or more discrete interface devices.

190. (canceled)

191. (canceled)

192. The system of claim 155, wherein said two-or-more absent information configured discrete interface device set determining module comprises:
a discrete interface device list maintaining module; and
a two-or-more absent information configured discrete interface device set selecting from list module configured to determine a set of discrete interface devices by selecting two or more discrete interface devices from the maintained list of discrete interface devices.

193. The system of claim 192, wherein said discrete interface device list maintaining module comprises:
a discrete interface device particular interval information receiving module configured to update the list of discrete interface devices at predetermined intervals.

194. The system of claim 192, wherein said discrete interface device list maintaining module comprises:
a discrete interface device information receiving module configured to receive information regarding one or more of the discrete interface devices of the list of discrete interface devices; and
a discrete interface device list updating module configured to update the list of discrete interface devices at particular intervals.

195. The system of claim 194, wherein said discrete interface device list updating module comprises:
a discrete interface device predetermined interval list updating module configured to update the list of discrete interface devices at predetermined intervals.

196. (canceled)

197. (canceled)

198. The system of claim 194, wherein said discrete interface device list updating module comprises:
a discrete interface device list updating on information receipt module configured to update the list of discrete interface devices each time information regarding one or more of the discrete interface devices of the list of discrete interface devices is received.

199. The system of claim 194, wherein said discrete interface device list updating module comprises:
a discrete interface device list updating on access module configured to update the list of discrete interface devices each time the list of discrete interface devices is accessed.

200. (canceled)

201. (canceled)

202. The system of claim 194, wherein said discrete interface device information receiving module comprises:
a discrete interface device property information receiving module configured to receive information regarding a property of one or more discrete interface devices of the list of discrete interface devices.

203. (canceled)

204. The system of claim 192, wherein said discrete interface device list maintaining module comprises:
a discrete interface device having particular property list adding module configured to add discrete interface devices having a particular property to the list of discrete interface devices; and
a discrete interface device meeting particular condition list removing module configured to remove discrete interface devices from the list of discrete interface devices, when at least one particular condition is met.

205. The system of claim 204, wherein said discrete interface device meeting particular condition list removing module comprises:
a discrete interface device having particular location list removing module configured to remove a discrete interface device from the list of discrete interface devices, based on a location of the discrete interface device.

206. (canceled)

207. The system of claim 204, wherein said discrete interface device having particular property list adding module comprises:
a discrete interface device connected to a particular communication network list adding module configured to add a discrete interface device to the list of discrete interface devices upon detection of a connection to a communication network by the discrete interface device.

208. The system of claim 204, wherein said discrete interface device having particular property list adding module comprises:
a discrete interface device having positioning sensor list adding module configured to add a discrete interface device having a positioning sensor to the list of discrete interface devices.

209. (canceled)

210. The system of claim 155, wherein said two-or-more absent information configured discrete interface device set determining module comprises:
a two-or-more absent information configured discrete interface device set determining from members of a particular service module configured to determine a set of two or more discrete interface devices from discrete interface devices that are members of a particular service.

211. The system of claim 210, wherein said two-or-more absent information configured discrete interface device set determining from members of a particular service module comprises:
a two-or-more absent information configured discrete interface device set determining from subscribers of a particular service module configured to determine a set of two or more discrete interface devices from discrete interface devices that are subscribers to a particular service.

212. The system of claim 210, wherein said two-or-more absent information configured discrete interface device set determining from members of a particular service module comprises:
a two-or-more absent information configured discrete interface device set determining from logged-in interface devices module configured to determine a set of two or more discrete interface devices from discrete interface devices that are logged in to a particular service.

213. The system of claim 210, wherein said two-or-more absent information configured discrete interface device set determining from members of a particular service module comprises:
a two-or-more absent information configured discrete interface device set determining via particular service module configured to determine, using a particular service, a set of two or more discrete interface devices from discrete interface devices that are logged in to the particular service.

214. The system of claim 210, wherein said two-or-more absent information configured discrete interface device set determining from members of a particular service module comprises:
a two-or-more absent information configured discrete interface device set determining using feature of particular service module configured to determine, using at least one feature of a particular service, a set of two or more discrete interface devices from a set of discrete interface devices that are logged in to the particular service.

215. (canceled)

216. The system of claim 210, wherein said two-or-more absent information configured discrete interface device set determining from members of a particular service module comprises:
a two-or-more absent information configured discrete interface device set determining from members of a social networking service module configured to determine a set of discrete interface devices from discrete interface devices that are logged in to a social networking service.

217. The system of claim 210, wherein said two-or-more absent information configured discrete interface device set determining from members of a particular service module comprises:
a two-or-more absent information configured discrete interface device set determining from logged in members of a service module configured to determine, using data related to a particular service, a set of two or more discrete interface devices from discrete interface devices that are logged in to the particular service.

218. (canceled)

219. (canceled)

220. The system of claim 210, wherein said two-or-more absent information configured discrete interface device set determining from members of a particular service module comprises:
a two-or-more absent information configured discrete interface device set determining from participants of an online multiplayer game module configured to determine a set of two or more discrete interface devices from discrete interface devices that are participants in to an online multiplayer game.

221. The system of claim 210, wherein said two-or-more absent information configured discrete interface device set determining from members of a particular service module comprises:
a two-or-more absent information configured discrete interface device set determining from participants of an online virtual world module configured to determine a set of two or more discrete interface devices from a set of discrete interface devices that are participants in to an online virtual world.

222. (canceled)

223. (canceled)

224. The system of claim 210, wherein said two-or-more absent information configured discrete interface device set determining from members of a particular service module comprises:
a two-or-more absent information configured discrete interface device set determining from members of e-commerce service module configured to determine a set of two or more discrete interface devices from a set of discrete interface devices that are logged in to an e-commerce market service.

225. (canceled)

226. (canceled)

227. The system of claim 155, wherein said two-or-more absent information configured discrete interface device set determining module comprises:
a discrete interface device information polling module configured to poll at least two discrete interface devices for information regarding the at least two discrete interface devices; and
a two-or-more absent information configured discrete interface device set polling information based determining module configured to determine the set of two or more discrete interface devices configured to carry out the one or more subtasks at a particular time based on the received polled information.

228. The system of claim 155, wherein said discrete interface device set transmission facilitation module comprises:
a capable entity discrete interface device set transmitting module configured to transmit the set of two or more discrete interface devices to an entity capable of transmitting the one or more subtasks.

229. The system of claim 155, wherein said discrete interface device set transmission facilitation module comprises:
a selecting interface device for transmission entity set transmitting module configured to transmit the set of two or more discrete interface devices to an entity configured to select two or more discrete interface devices to receive transmission of the one or more subtasks.

230. (canceled)
